(19) United States
(12) Patent Application Publication
(10) Pub. No.: US 2026/0337796 A1
(43) Pub. Date: Oct. 29, 2026

(54) SUPPORTED OR REINFORCED LAYERS FOR ELECTROCHEMICAL CELLS

(71) Applicant: ELECTRIC HYDROGEN CO., Devens, MA (US)

(72) Inventors: Ruofan Wang, Centennial, CO (US); Nemanja Danilovic, El Sobrante, CA (US); Raffi Garabedian, Los Altos, CA (US); Jigish Trivedi, Pleasanton, CA (US); Jason Robinson, Hopedale, MA (US); David Eaglesham, Lexington, MA (US); Jeremy Gershonowitz, Cambridge, MA (US)

(21) Appl. No.: 19/123,171

(22) PCT Filed: Oct. 26, 2023
(86) PCT No.: PCT/US2023/077954

§ 371 Date: Apr. 22, 2025

Related U.S. Application Data
(60) Provisional application No. 63/420,072, filed on Oct. 27, 2022.

(51) Int. Cl. C25B 11/032; C25B 1/04; C25B 9/23; C25B 9/60

(52) U.S. Cl. CPC C25B 11/032; C25B 1/04; C25B 9/23; C25B 9/60

(57) ABSTRACT

The following disclosure relates to electrochemical or electrolysis cells and components thereof, specifically supported or reinforced gas diffusion layers (GDLs), supported or reinforced porous transport layers (PTLs), and improved cathode and/or anode flow fields within electrochemical cells. In one example, the electrochemical cell includes a supporting layer positioned between the flow field and the membrane, wherein the supporting layer is configured to reduce localized deformation on the PTL or the GDL, reduce or prevent short circuiting of the electrochemical cell, improve electrochemical efficiency of the electrochemical cell, improve pressure distribution across the PTL or the GDL, improve current distribution across the PTL or the GDL, improve fluid distribution within the electrochemical cell, reduce defects in a catalyst coating on the membrane, and/or extend a life of the electrochemical cell in comparison with a similar electrochemical cell not having the supporting layer.

This application claims the benefit of U.S. Provisional Patent Application No. 63/420,072, filed Oct. 27, 2022, which is hereby incorporated by reference in its entirety.

### FIELD

The following disclosure relates to electrochemical or electrolysis cells and components thereof. More specifically, the following disclosure relates to supported or reinforced gas diffusion layers (GDLs), supported or reinforced porous transport layers (PTLs), and improved flow fields within electrochemical cells.

### BACKGROUND

Hydrogen has been considered as an ideal energy carrier to store renewable energy. Proton exchange membrane water electrolysis (PEMWE) as a means for hydrogen production offers high product purity, fast load response times, small footprints, high efficiencies, and low maintenance efforts. It is regarded as a promising technology, especially when coupled with renewable energy sources.

An electrolysis cell or system uses electrical energy to drive a chemical reaction. For example, water is split to form hydrogen and oxygen. The products may be used as energy sources for later use. In recent years, improvements in operational efficiency have made electrolyzer systems competitive market solutions for energy storage, generation, and/or transport. For example, the cost of generation may be below $10 per kilogram of hydrogen in some cases. Increases in efficiency and/or improvements in operation will continue to drive the installation of electrolyzer systems.

Porous transport layers (PTLs) and gas diffusion layers (GDLs) play important roles in electrochemical cell performance. A PTL, positioned between an anode catalyst layer and an anode flow field of the electrochemical cell, may assist in transporting water and oxygen on the anode side and in transporting electrons away from the anode catalyst layer. A GDL, positioned between a cathode catalyst layer and a cathode flow field of the electrochemical cell, may assist in transporting hydrogen on the cathode side of the cell and in transporting electrons towards the cathode catalyst layer.

There remains a desire for improved performance properties within electrochemical cells, including improved porous transport layers and gas diffusion layers.

### SUMMARY

In one embodiment, an electrochemical cell includes an electrode having a flow field, a membrane, a porous transport layer (PTL) or gas diffusion layer (GDL) positioned between the membrane and the flow field, and a supporting layer positioned between the PTL or GDL and the flow field. The supporting layer is configured to reduce localized deformation on the PTL or the GDL, reduce or prevent short circuiting of the electrochemical cell, improve electrochemical efficiency of the electrochemical cell, improve pressure distribution across the PTL or the GDL, improve current distribution across the PTL or the GDL, improve fluid distribution within the electrochemical cell, reduce defects in a catalyst coating on the membrane, or extend a life of the electrochemical cell in comparison with a similar electrochemical cell not having the supporting layer.

In another embodiment, an electrochemical cell includes an electrode having a flow field, a membrane, and a self-reinforced porous transport layer (PTL) or self-reinforced gas diffusion layer (GDL) positioned between the membrane and the flow field. The self-reinforced PTL or the self-reinforced GDL is configured to reduce localized deformation on the PTL or the GDL, reduce or prevent short circuiting of the electrochemical cell, improve electrochemical efficiency of the electrochemical cell, improve pressure distribution across the PTL or the GDL, improve current distribution across the PTL or the GDL, improve fluid distribution within the electrochemical cell, reduce defects in a catalyst coating on the membrane, or extend a life of the electrochemical cell in comparison with a similar electrochemical cell not having the self-reinforced PTL or the self-reinforced GDL.

In another embodiment, an electrode flow field for an electrochemical cell includes a plurality of lands configured to abut a gas diffusion layer (GDL) or porous transport layer (PTL) of the electrochemical cell. The electrode flow field further includes a plurality of channels configured to direct fluid flow to or from the GDL or the PTL, wherein each channel of the plurality of channels is positioned between two adjacent lands of the plurality of lands. The electrode flow field further includes one or more supporting layers, wherein each supporting layer of the one or more supporting layer is positioned within an opening of a respective channel of the plurality of channels, and wherein each supporting layer of the one or more supporting layers is configured to improve pressure distribution across the PTL or the GDL and/or improve fluid distribution within the electrochemical cell.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

Exemplary embodiments are described herein with reference to the following drawings.

FIG. 1A depicts an example of an electrolytic cell.

FIG. 1B depicts an electrochemical stack having a plurality of electrochemical cells.

FIG. 2 depicts an additional example of an electrolytic cell.

FIGS. 3A and 3B depict cross-sectional views of an exemplary electrochemical cell with a limited number of flow channels of flow fields depicted for clarity.

FIGS. 4A and 4B depict a side view and a top view, respectively, of portion of such an electrode flow field having a limited number of flow channels and lands depicted for clarity.

FIGS. 5A and 5B depict an example of high-pressure and low-pressure areas generated on the membrane from the cathode flow field and anode flow field, respectively.

FIGS. 6A and 6B depict a photo and surface profile of a catalyst-coated membrane after being compressed in between a carbon paper GDL (FIG. 6A) and Ti fiber PTL (FIG. 6B).

FIG. 7 depicts pressure distributions on a membrane for a cross-flow flow field design.

FIG. 8 depicts a Ti fiber contact with anode catalyst layer.

FIG. 9 depicts an example of differences in membrane thickness under lands and under channels of the flow field.

FIG. 10 depicts an example of an electrochemical cell having a GDL supporting layer providing reinforcement or support for an adjacent GDL.

FIGS. 11A-11D depict examples of various GDL supporting layer structures.

FIGS. 12A-12D depict examples of the GDL supporting layer structures of FIGS. 11A-11D overlaid with an adjacent flow field and the various lands and channels of the flow field.

FIGS. 13A-13C depict additional examples of various GDL supporting layer structures.

FIGS. 14A-14C depict examples of the GDL supporting layer structures of FIGS. 13A-13C overlaid with an adjacent flow field and the various lands and channels of the flow field.

FIG. 15 depicts an example of an electrochemical cell having a 3D-structured GDL supporting layer providing reinforcement or support for an adjacent GDL.

FIG. 16 depicts an example of an electrochemical cell having a PTL supporting layer providing reinforcement or support for an adjacent PTL.

FIG. 17 depicts an example of an electrochemical cell having a 3D-structured PTL supporting layer providing reinforcement or support for an adjacent PTL.

FIG. 18 depicts an example of a self-reinforced PTL.

FIGS. 19A-19C depict an additional example of a self-reinforced PTL that includes a tape casted titanium mesh composition integrated with a PTL.

FIG. 20A depicts an example of an electrode flow field and an adjacent GDL or PTL supporting layer.

FIG. 20B depicts a flow field having flow field supporting segments or flow field supporting layers incorporated within the flow field itself.

FIG. 21A depicts a side view and a top view of an example of an electrode flow field without any added flow field supporting layer.

FIG. 21B depicts a side view and a top view of an example of an electrode flow field having flow field supporting segments or flow field supporting layers incorporated within the flow field itself.

FIGS. 22A-22C depict an example of fluid flow within a flow field without any added flow field supporting layer.

FIGS. 23A-23C depict an example of fluid flow within a flow field with an added flow field supporting layer.

FIG. 24 depicts simulated polarization curves for different cell configurations.

FIG. 25 depicts an improved current distribution at a cathode catalyst layer/GDL interface.

FIG. 26 depicts an improved current distribution at an anode catalyst layer/PTL interface.

FIG. 27 depicts examples of the impact of a Ti mesh supporting layer on the distribution of pressure on an active area of an electrochemical cell.

### DETAILED DESCRIPTION

The following disclosure provides supported or reinforced Gas Diffusion Layers (GDLs), supported or reinforced Porous Transport layers (PTLs), and improved flow fields within electrochemical or electrolytic cells for hydrogen gas and oxygen gas production through the splitting of water.

The addition of a supporting layer adjacent to the GDL or PTL, a self-reinforcement of the GDL or PTL, or an improved flow field within the electrochemical cell may be advantageous for one or more reasons. First, the supporting/reinforced layer or modified flow field may assist in providing better electron transport within the cell. This may include improved current spreading or distribution, improved catalyst utilization within channel areas, and/or less ohmic loss. Second, the supporting/reinforced layer or modified flow field may assist in providing better mechanical support within the cell. This may include reducing localized deformation on the GDL or PTL and/or reducing stretching within the catalyst layer therein mitigating a discontinuity in electron transport between catalyst particles due to pillowing.

Detailed examples of various supporting layers for GDL and PTL layers, self-reinforced GDL/PTL layers, and modified flow fields are discussed in greater detail below.

### DEFINITIONS

As used herein, “providing” may refer to the provision of, generation or, presentation of, or delivery of that which is provided. Providing may include making something available. For example, providing a powder may refer to a process of making the powder available, or delivering the powder, such that the powder can be used as set forth in a method described herein. As used herein, providing also may refer to measuring, weighing, transferring, combining, or formulating.

As used herein, “casting” may refer to depositing or delivering a cast solution or slurry onto a substrate. Casting may include, but is not limited to, tape casting, dip coating, and doctor blading.

As used herein, “green state” may refer to a composition or structure that has not undergone any subsequent heat treatment to coolest the composition into a solid or porous mass. Specifically, “green state” may refer to a composition or structure that has not been sintered. Non-limiting examples disclosed herein may refer to an unsintered fiber felt composition (e.g., unsintered titanium fiber felt), an unsintered composition or structure (e.g., unsintered titanium powder), or combinations thereof.

As used herein, “sintered” or “sintered state” may refer to a sintered composition or structure, such as a sintered fiber felt (e.g., sintered titanium felt), sintered structure (e.g., titanium powder that has been sintered into a solid or porous mass), or combinations thereof.

As used herein, “sintering” may refer to heating a starting composition (e.g., a powdered material or fiber felt) to coalesce the starting composition into a solid or porous mass without liquefaction, (e.g., heating the starting composition to a temperature below the melting point of a compound within the starting composition-such as a temperature below the melting point of titanium).

As used herein, a “thickness” by which is film is characterized refers to the distance, or median measured distance, between the top and bottom faces of a film in a direction perpendicular to the plane of the film layer. As used herein, the top and bottom faces of a film refer to the sides of the film extending in a parallel direction of the plane of the film having the largest surface area.

As used herein, a “Ti fiber felt structure” may refer to a structure created from microporous Ti fibers. The Ti fiber felt structure may be sintered together by fusing some of the fibers together. Ti fiber felt may be made by a special laying process and a special ultra-high temperature vacuum sintering process. The Ti fiber felt may have an excellent three-dimensional network, porous structure, high porosity, large surface area, uniform pore size distribution, special pressure, and corrosion resistance, and may be rolled and processed. However, in certain instances, Ti fiber felt may have poor mass transport properties when compressed.

As used herein, a “sintered Ti structure” may refer to a structure created by Ti powder which is pressed together using binding under high pressure. Metal injection molding (MIM), otherwise known as powder injection molding, is a well-established and cost-effective method of fabricating small-to-moderate size metal components in large quantities. It is derived from the method plastic injection molding, whereby mixing of a metal powder with a polymer binder forms the feedstock, which is then injected into a mold, after which the binder is removed via heat treatment under vacuum before final sintering. With Ti metal powder, however, the binders used in MIM results in the introduction of carbon into the matrix due to insufficient binder removal prior to sintering and/or deleterious reactions between the decomposing binder, debinding atmosphere, and the metal phase. Sintered Ti may be more rigid and may not compress as well as Ti fiber felt. The electrical conductibility of sintered Ti may not be as good as Ti fiber felt. However, sintered Ti can be very smooth, which may be advantageous for electrochemical cells with thinner membranes.

As used herein, a “perforated Ti sheet structure” may refer to a structure created from Ti sheets with perforated holes. The holes may be created or drilled by lasers. Each of the holes may be 25-100 microns in diameter extruding through the thickness of the sheet.

As used herein, “laser treatment” may refer to treating a material by utilizing a laser to melt or etch a localized area, surface of a material, or ablate the material creating one or more holes through the thickness of the material.

### Electrochemical Cells

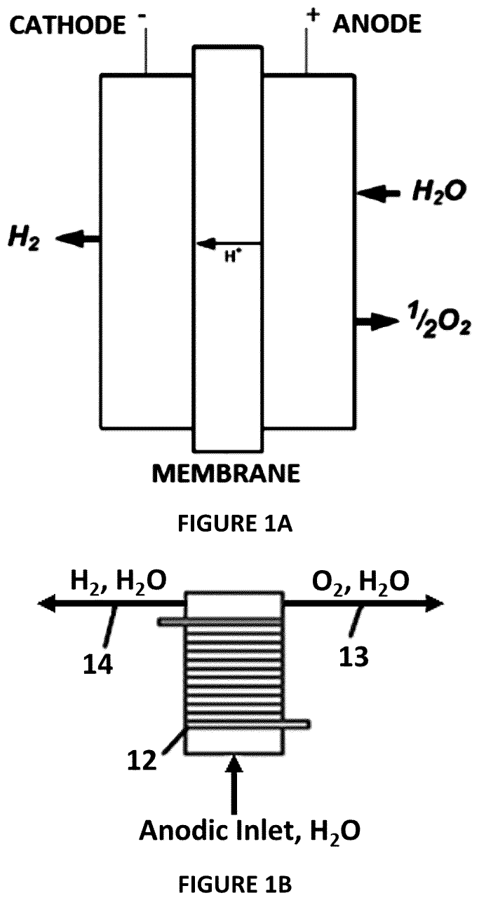

FIG. 1A depicts an example of an electrochemical or electrolytic cell for hydrogen gas and oxygen gas production through the splitting of water. The electrolytic cell includes a cathode, an anode, and a membrane positioned between the cathode and anode. The membrane may be a catalyst coated membrane (CCM) such as a proton exchange membrane (PEM). Proton Exchange Membrane (PEM) electrolysis involves the use of a solid electrolyte or ion exchange membrane. Within the water splitting electrolysis reaction, one interface runs an oxygen evolution reaction (OER) while the other interface runs a hydrogen evolution reaction (HER). For example, the anode reaction is H₂O→2H⁺+½O₂+2e and the cathode reaction is 2H⁺+2e→H₂.

The electrochemical cell may be included within an electrochemical system having an electrochemical stack that includes a plurality of electrochemical cells. FIG. 1B depicts an example of an electrochemical system including an electrochemical stack having a plurality of electrochemical cells such as depicted in FIG. 1A. In certain examples, the electrochemical stack may contain 50-1000 cells, 50-100 cells, 500-700 cells, or more than 1000 cells. Any number of cells may make up a stack. The electrochemical cell or the plurality of electrochemical cells within the electrochemical stack may be configured to operate with 200 mV or less of pure resistive loss when operating at a high current density (e.g., at least 3 Amps/cm², at least 4 Amps/cm², at least 5 Amps/cm², at least 6 Amps/cm², at least 7 Amps/cm², at least 8 Amps/cm², at least 9 Amps/cm², at least 10 Amps/cm², at least 11 Amps/cm², at least 12 Amps/cm², at least 13 Amps/cm², at least 14 Amps/cm², at least 15 Amps/cm², at least 16 Amps/cm², at least 17 Amps/cm², at least 18 Amps/cm², at least 19 Amps/cm², at least 20 Amps/cm², at least 25 Amps/cm², at least 30 Amps/cm², in a range of 1-30 Amps/cm², in a range of 3-20 Amps/cm², in a range of 3-15 Amps/cm², in a range of 3-10 Amps/cm², or in a range of 10-20 Amps/cm²). In additional examples, the amount of water (e.g., deionized (DI) water) transferred to or circulated through each cell of the stack may be in a range of 0.25-5 mL/Amp/cell/min.

As illustrated in the system of FIG. 1B, water (H₂O) may be supplied to the anodic inlet of an electrolytic cell stack 12. In some embodiments, only the anodic inlet of the cell stack 12 may receive water. In these embodiments, the cathode side of the cell stack 12 may not receive water (e.g., a dry cathode side may be used). In another embodiment, a cathode inlet may also receive water, wherein the water may be supplied to the cathode inlet to cool the cell stack 12 during electrolysis.

The water supplied to the anodic inlet flows to an anodic inlet manifold that distributes the water to the anode side of the plurality of cells contained with the cell stack 12. In embodiments where water is supplied to the cathode inlet, water supplied to the cathode inlet flows to a cathodic inlet manifold that distributes the water to the cathode side of the plurality of cells in the cell stack 12. In certain examples, the amount of water (e.g., deionized (DI) water) transferred to or circulated through each cell of the stack may be in a range of 0.25-5 mL/Amp/cell/min.

During electrolysis, oxygen (O₂) is produced at the anode side of the electrolytic cells and hydrogen (H₂) is produced at the cathode side of the electrolytic cells. Specifically, a water splitting electrolysis reaction is configured to take place within each individual cell in the cell stack 12. Each cell includes one interface (the anode side of the cell) configured to run an oxygen evolution reaction (OER) and another interface (the cathode side of the cell) configured to run a hydrogen evolution reaction (HER) (such as depicted in FIG. 1A).

During electrolysis, some of the water supplied to the anode side of an electrolytic cell may not be converted into oxygen. Accordingly, a two-phase flow of oxygen and unreacted water is outlet from each of the anode sides of the cells into an anodic outlet manifold 13. The two-phase flow of oxygen and unreacted water flows from out of the cell stack 12 through the anodic outlet manifold 13. This stream within the anodic outlet manifold 13 may be configured to be transferred to a gas detection and conditioning system, such as described in greater detail below, for analysis of the composition within the stream. Specifically, this anodic stream may be analyzed to identify if any undesirable hydrogen gas has leaked (i.e., cross-leaked) across the membranes from the cathode sides of the cells to the anode sides of the cells within the cell stack.

Additionally, in some embodiments, water may be supplied to the cathode side of the cell stack as a coolant. Accordingly, a two-phase flow of hydrogen and water is outlet from each of the cathode sides of the cells to a cathodic outlet manifold 14. The two-phase flow of hydrogen and water flows out of the cell stack 12 through the cathodic outlet manifold 14. Similarly, this particular stream within the cathodic outlet manifold 14 may be configured to be transferred to a gas detection and conditioning system (separate from the anodic gas detection and conditioning system) for analysis of the composition within the stream. Specifically, this cathodic stream may be analyzed to identify if any undesirable oxygen gas has leaked (i.e., cross-leaked) across the membranes from the anode sides of the cells to the cathode sides of the cells within the cell stack.

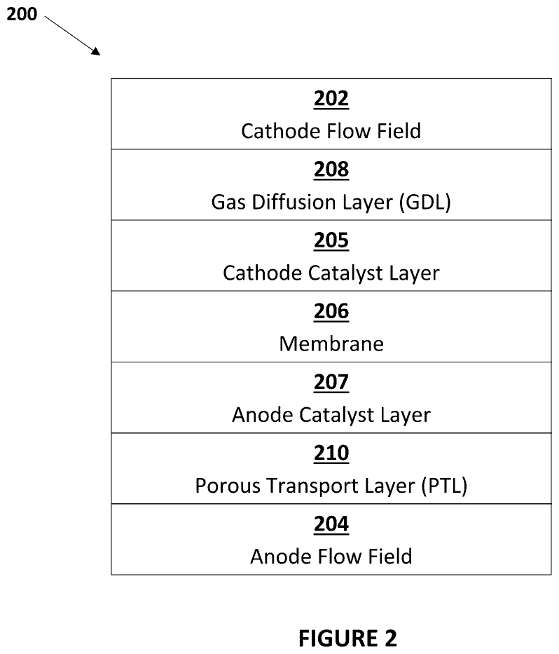

FIG. 2 depicts an additional example of an electrochemical or electrolytic cell. Specifically, FIG. 2 depicts a portion of an electrochemical cell 200 having a cathode flow field 202, an anode flow field 204, and a membrane 206 positioned between the cathode flow field 202 and the anode flow field 204.

In certain examples, the membrane 206 may be a catalyst coated membrane (CCM) having a cathode catalyst layer 205 and/or an anode catalyst layer 207 positioned on respective surfaces of the membrane 206. As used throughout this disclosure, the term “membrane” may refer to a catalyst coated membrane (CCM) having such catalyst layers.

In certain examples, the membrane may have an overall thickness that is less than 1000 microns, less than 500 microns, less than 100 microns, less than 50 microns, less than 10 microns, less than 5 microns, less than 2 microns, less than 1 micron, in a range of 1-1000 microns, in a range of 2-500 microns, in a range of 5-100 microns, or in a range of 10-50 microns.

In certain examples, additional layers may be present within the electrochemical cell 200. For example, one or more additional layers 208 may be positioned between the cathode flow field 202 and membrane 206. In certain examples, this may include a gas diffusion layer (GDL) 208 may be positioned between the cathode flow field 202 and membrane 206. This may be advantageous in providing a hydrogen diffusion barrier adjacent to the cathode on one side of the multi-layered membrane to mitigate hydrogen crossover to the anode side.

In certain examples, the GDL is made from a carbon paper or woven carbon fabrics. The GDL is configured to allow the flow of hydrogen gas to pass through it. The thickness of the GDL may be within a range of 100-1000 microns, for example. The thickness may affect the mass transport within the cell as well as the durability/deformability and electrical/thermal conductivity of the GDL. In other words, a thinner GDL may provide better mass transport, lower resistance, and a reduction in durability (e.g., greater chance for localized deformation).

Similarly, one or more additional layers 210 may be present in the electrochemical cell between the membrane 206 and the anode 204. In certain examples, this may include a porous transport layer (PTL) positioned between the membrane 206 (e.g., the anode catalyst layer 207 of the catalyst coated membrane 206) and the anode flow field 204.

In certain examples, the PTL is made from a titanium mesh/felt. Similar to the GDL, the PTL is configured to allow the transportation of the reactant water to the anode catalyst layers, remove produced oxygen gas, and provide good electrical conductivity for effective electron conduction. The thickness of the PTL may be within a range of 100-1000 microns, for example. The thickness may affect the mass transport within the cell as well as the durability/deformability and electrical/thermal conductivity of the PTL. In other words, a thinner PTL may provide better mass transport and a reduction in durability (e.g., greater chance for localized deformation).

In some examples, an anode catalyst coating layer may be positioned between the anode 204 and the PTL.

The cathode 202 and anode 204 of the cell may individually include a flow field plate composed of metal, carbon, or a composite material having a set of channels machined, stamped, or etched into the plate to allow fluids to flow inward toward the membrane or out of the cell.

Flow plates in electrochemical cells are not only responsible for delivery of reactants and removal of products through flow fields, but also electron conduction between current collectors to the membrane electrode assembly (MEA). In certain examples, the electrochemical cell may employ flow fields with straight or curved channels, interdigitated channels, mesh or screen type features. In these examples, the flow plate may include a solid metal piece that is electrically conductive, such as lands in channel-based flow fields or the metal strands/fibers in mesh-type flow fields. In between these metal pieces, there is an unsupported span such as the channels or the ‘pore’ area in a mesh type flow fields. These open areas and the areas on the catalyst layer coinciding these open areas rely on lateral (or in-plane) electron conduction for the electrochemical reaction to occur. Uniform and efficient delivery of electrons may advantageously provide uniform current distribution and minimal ohmic losses in electrochemical cells.

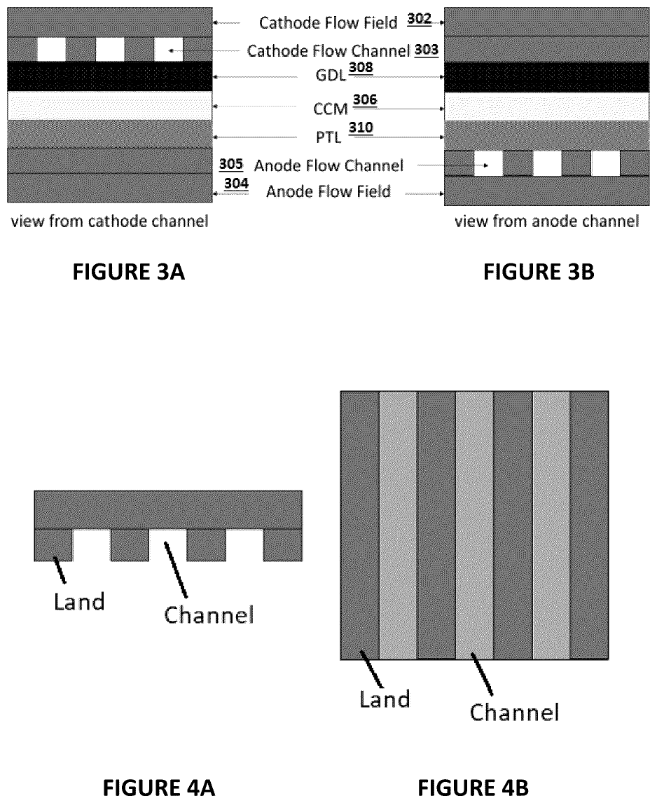

FIGS. 3A and 3B depict an example of an electrochemical or electrolytic cell, wherein examples of flow fields are depicted. In this particular example, the electrochemical cell includes a cathode flow field 302, cathode flow channels 303, an anode flow field 304, anode flow channels 305, and a membrane 306 positioned between the cathode and the anode. Additionally, the electrochemical cell 300 includes a gas diffusion layer 308 positioned between the catalyst coated membrane 306 and the cathode flow channels 303. Further, a porous transport layer 310 is positioned between the catalyst coated membrane 306 and the anode flow channels 305.

In the particular example depicted in FIGS. 3A and 3B, the cathode and anode flow fields are arranged to provide a cross-fluid flow. In such a cross-fluid arrangement, the fluid flow through the cathode flow channels is arranged perpendicular to the fluid flow through the anode flow channels. Specifically, FIG. 3A depicts the cross-sectional view of the electrochemical cell with the cathode flow channels displayed, while FIG. 3B depicts the cross-sectional view of the electrochemical cell rotated 90 degrees to display the anode flow channels.

Regarding these anode and cathode flow fields depicted in FIGS. 3A and 3B, such flow fields may be configured to have paths of channels and land. The channels are configured for directing the flow of water and gas, while the lands are configured to contact an adjacent layer of the electrochemical cell (e.g., the GDL or PTL). FIGS. 3A and 3B depict examples of cells having three cathode flow channels and three anode flow channels, respectively. The number of flow channels are depicted for simplicity of a design, and in potential commercial use, may include many more flow channels. As such, the disclosure is not limited to such configurations as depicted in FIGS. 3A and 3B.

FIGS. 4A and 4B depict a side view and a top view, respectively, of such an electrode flow field having a plurality of channels and lands. In this particular example, the flow field includes 3 parallel channels and 4 lands, wherein each channel is positioned between adjacent lands.

As noted above, in the example depicted in FIGS. 3A and 3B, the direction of fluid flow within the cathode flow field and the anode flow field may have a cross-flow configuration, wherein the flow of fluid through the anode flow field channels is in an offset direction (e.g., 90 degrees offset) from the flow of fluid through the cathode flow field channels.

In alternative examples, the flow fields may have a co-flow configuration or a counter-flow configuration. For example, in a co-flow configuration, the flow of fluid through the anode flow field channels is in the same direction as the flow of fluid through the cathode flow field channels. In a counter-flow configuration, the flow of fluid through the anode flow field channels is in an opposite direction as the flow of fluid through the cathode flow field channels.

The orientation or configuration of fluid flow between the anode flow field and cathode flow field may be advantageous in adjusting or controlling the pressure distribution or temperature distribution within the electrochemical cell.

For parallel channel flow fields, regardless of flow direction, the channels from cathode and channels from anode may be in a cross pattern or parallel pattern. Additional channel patterns are also possible.

In proton exchange membrane water electrolysis (PEMWE), the proton exchange membrane may be a perfluorosulfonic acid (PFSA) based polymer, which is soft and flexible. As such, to be able to distribute the stack pressure more evenly on the membrane, the porous transport layer and gas diffusion layer must have a rigidity or support structure capable of uniformly distributing the pressure from the lands of flow field onto the membrane.

Unfortunately, these PTLs and GDLs may not be ideal in providing uniform or even distribution of the pressure created with the adjacent flow fields. This uneven pressure distribution may result in an uneven utilization of the catalyst active area, as there are areas with lower resistance that are accessed via a lower voltage drop.

For example, certain GDLs may be made from a carbon paper or cloth including carbon fibers. Such compositions are not 100% rigid because of two requirements: (a) the composition is porous to remove H2 from CCM, (b) the composition has some level of compressibility in order to provide manufacturing tolerance of the flow field under compression.

Similarly, certain PTLs may be made of a porous titanium felt or sheet and/or sintered Ti fibers or Ti powders. Relatively speaking, Ti based PTLs may be more rigid than carbon-based GDLs, because sintered Ti is a rigid and hard material. For example, unalloyed Grade 2 Ti has a tensile strength of 485 MPa and a Young's modulus of 105-120 GPa, while graphite has a tensile strength is 14 MPa and a Young's modulus of 11.5 GPa. However, such PTLs are also not 100% rigid, due to the porosity and morphology of the composition. The ability of the diffusion layer to span the flow channel is determined by its flexural strength.

Because these GDLs and PTLs are not 100% rigid, when these materials are combined and pressed together with the membrane in between two flow fields, more pressure may be transferred onto the areas on membrane where both land from cathode flow field and land from anode flow field meet than the other areas.

In other words, the ribs/lands of the flow fields may transfer pressure to an adjacent GDL/PTL upon compression, while the areas under channels may not transfer enough pressure to GDL/PTL. Because these GDLs and PTLs are not 100% rigid, the membrane will not see an even distribution of pressure. Instead, more pressure may be transferred to the areas under the lands of flow fields.

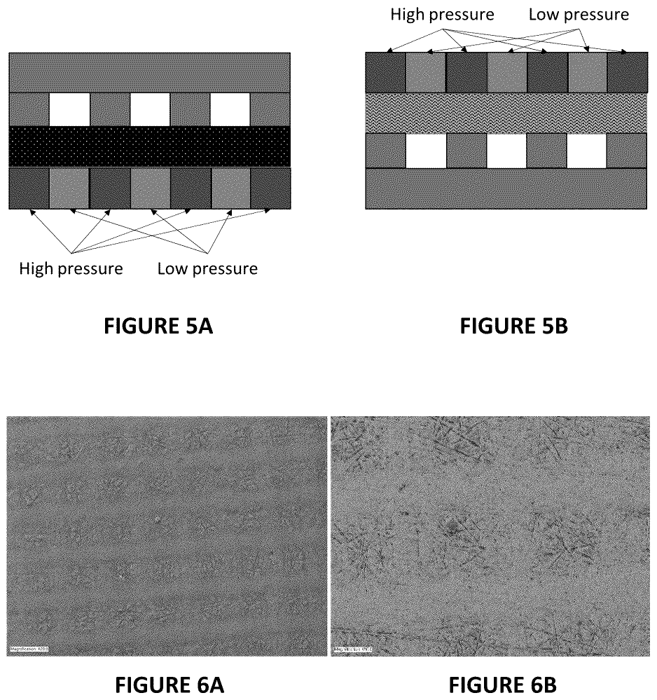

FIGS. 5A and 5B depict an example of such high-pressure and low-pressure areas generated on the membrane. Specifically, FIG. 5A depicts an example of the cathode side of an electrochemical cell having a cathode flow field with 3 parallel channels and 4 lands. The lands of the cathode flow field contact the adjacent GDL. Due to compression of the cell components, this creates high pressure areas on the GDL that are not evenly distributed. As depicted in the figure, this may create high pressure areas onto the membrane below the GDL, wherein these areas correlate with the contact areas between the lands and GDL. Additionally, low pressure areas may be generated on the membrane, wherein these areas on the membrane correlate with the areas beneath the 3 parallel channels of the cathode flow field.

Similarly, FIG. 5B depicts an example of the anode side of an electrochemical cell having an anode flow field with 3 parallel channels and 4 lands. The lands of the anode flow field contact the adjacent PTL. Due to compression of the cell components, this creates high pressure areas on the PTL that are not evenly distributed. As depicted in the figure, this may create high pressure areas onto the membrane above the PTL, wherein these areas correlate with the contact areas between the lands and PTL. Additionally, low pressure areas may be generated on the membrane, wherein these areas on the membrane correlate with the areas beneath the 3 parallel channels of the anode flow field.

Further evidence of the uneven pressure distribution issues from certain GDLs and PTLs may be observed by looking at a cross section of the cell membrane. Specifically, a cross-section of a membrane may be observed using a scanning electron microscope to identify changes in thickness of the membrane under the land or channel of the flow field as a function of cell compression. For the portions of membrane under the channels of the flow field, it may be observed that the thickness of the membrane does not change with increasing pressure/compression, but for the portions of the membrane under land of the flow field, it may be observed that the thickness of the membrane decreases with increasing pressure/compression.

Additional evidence of the uneven pressure distribution issues may be observed by looking at the imprint of Ti fibers/particles of a PTL onto the adjacent catalyst-coated membrane. FIGS. 6A and 6B depict a photo and surface profile of a membrane after being compressed in between a carbon paper GDL (FIG. 6A) and Ti fiber PTL (FIG. 6B). The images show that some areas of the CCM were compressed harder, which is evident by the obvious Ti fiber imprint in certain areas. Some areas of the CCM were compressed lighter, corresponding to the areas where almost no imprint of PTL is observed.

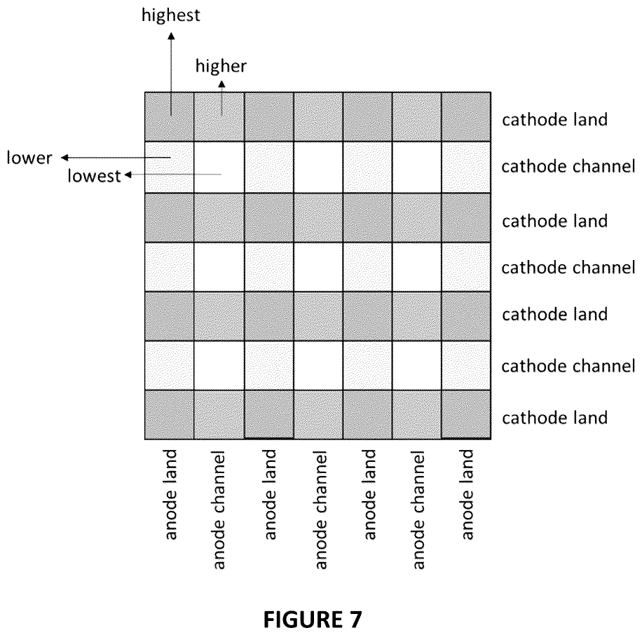

To further understand the uneven imprint created by the PTL onto the membrane depicted in FIGS. 6A and 6B, an understanding is needed of the pressure on different areas of the membrane. As illustrated in FIG. 7, areas of the membrane under cathode flow field lands has higher pressure compared to areas of the membrane under cathode flow field channels, and areas under anode flow field lands have higher pressure compared to areas under anode flow field channels. Specifically, FIG. 7 illustrates the pressure distribution on a membrane for a cross-flow flow field design, showing 4 different pressure zones.

When a membrane is compressed between a cathode flow field and anode flow field, pressure on the membrane that relates to areas positioned under both the cathode flow field lands and the anode flow field lands will be highest, while pressure on the membrane that relates to areas positioned under both the cathode flow field channels and the anode flow field channels will be the lowest. Because a carbon based GDL is more compressible than a Ti based PTL, the pressure under cathode flow field channel will be lower than the pressure under anode flow field channel.

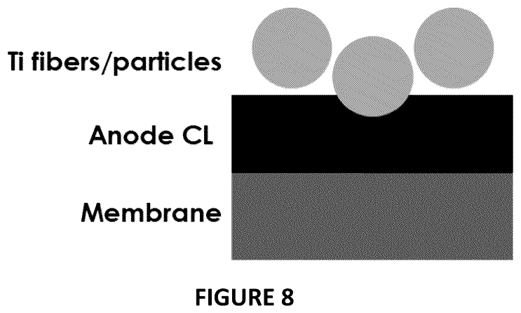

As noted above, this uneven pressure distribution may result in uneven utilization of the catalyst active area. When the membrane is compressed under a low compression, the contact between PTL/GDL and catalyst is worse under channel compared to under lands. FIG. 8 depicts the Ti fiber contact with anode catalyst layer. As a result of lower compression under channel, some Ti fibers/particles on the PTL surface are not in contact with the anode catalyst. The less contact between PTL and anode catalyst will not only result in higher contact resistance, but also lower catalyst utilization thus higher kinetic resistance. A similar effect may be expected between the GDL and cathode catalyst layer.

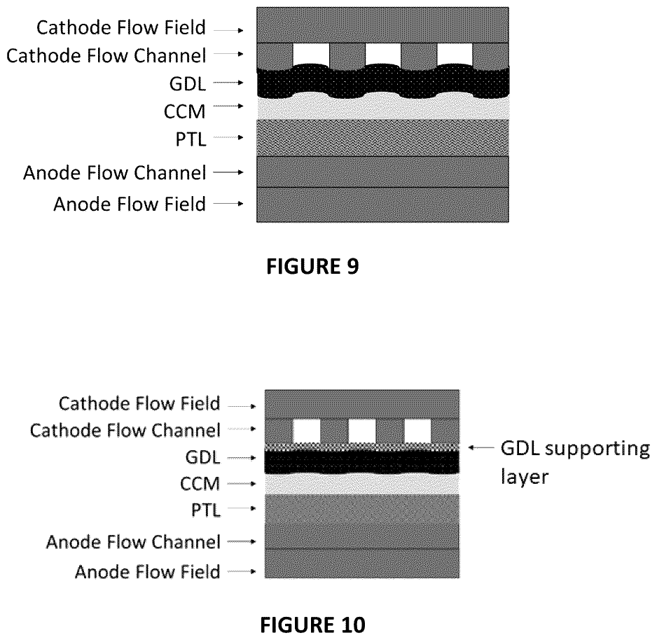

Additionally, an uneven pressure distribution may result in uneven thickness of membrane. For example, when the compression is higher on membrane, the areas under lands will be compressed higher so that the membrane will be thinned, and the areas under channels will be compressed lower so that the membrane thickness is unaffected. FIG. 9 illustrates the difference of membrane thickness under lands and under channels. As a result, current may be distributed unevenly, e.g., more current may be distributed to the areas where membrane is thinner (under the lands), because membrane resistance is a significant contributor to the total cell resistance. Also, hydrogen crossover may be higher in the areas where membrane is thinner. Further, defects in catalyst coating, PTL, and GDL may more likely cause failure at areas with thinner membrane.

Furthermore, uneven pressure distribution may cause a higher degradation rate because catalyst utilization is higher at higher compression areas, and catalyst utilization is lower at lower compression areas. Degradation caused by iridium (Ir) dissolution or caused by water contamination may be accelerated at higher compression areas, and less prominent at lower compression areas.

Based on these challenges and problems caused by these types of PTLs and GDLs, electrochemical or electrolysis cells with improved pressure distribution are desired. In other words, PTLs and GTLs with improved rigidity or pressure distribution characteristics are desired.

1. GDL with Supporting Layer

In one example, an improved electrochemical cell or cell stack may be developed through an improved, reinforced gas diffusion layer (GDL) that is positioned between a cathode flow field plate and a catalyst-coated membrane of a cell. FIG. 10 depicts an example of such an electrochemical cell having a GDL supporting layer providing reinforcement or support for an adjacent GDL. In this example, the electrochemical cell includes a cathode flow field, a GDL supporting layer, a GDL, a catalyst coated membrane (CCM), a PTL, and an anode flow field. The GDL supporting layer is positioned between the cathode flow field and GDL. As a result of the added rigidity and reinforcing support from the GDL supporting layer, deformation of the GDL and CCM may be reduced or minimized (as compared with the similar cell structure depicted in FIG. 9 that does not include the GDL supporting layer).

In this particular embodiment, the GDL may be reinforced through the addition of an additional reinforcement layer on the cathode side of the electrochemical cell. This reinforcement or GDL supporting layer may be advantageous in protecting the GDL from deformation during manufacturing or operation of the cell. Additionally, the GDL supporting layer may be advantageous in improving the uniformity of pressure distribution across the GDL. Further, the addition of a supporting or reinforcing layer may allow for the design or configuration of a less stiff or less dense GDL itself, as the supporting layer provides the required stiffness and strength to adsorb pressure from the adjacent layers such as the flow field lands.

The reinforcement layer or GDL supporting layer may be positioned between the cathode flow field and the GDL (as depicted in FIG. 10). In other examples, the GDL supporting layer may be positioned between the GDL and the membrane. In yet other examples, the GDL supporting layer may be sandwiched in between two separate GDL sheets, like a composite. Alternatively, the GDL may include fibers that may be manufactured or built around a reinforcing/GDL supporting metallic layer.

In certain examples, the GDL supporting layer may be adhered to one or both of the adjacent layers of the electrochemical cell. In other examples, the GDL supporting layer may be welded onto one or more land segments of the adjacent cathode flow field.

The GDL supporting layer may be a metallic foil, sheet, felt, or mesh having perforations or openings within the layer to allow fluid flow toward or from the adjacent GDL. The metallic composition, in certain embodiments, may include titanium, titanium alloy, niobium, niobium alloy, tantalum, tantalum alloy, stainless steel. The metallic foil, sheet, felt, or mesh may have surface treatment such as oxidation, anodizing, nitridation, carbidation. Furthermore, the metallic foil, sheet, felt, or mesh may have surface coating such as platinum, gold, niobium, metal nitride, metal carbide, or metal oxide.

In certain examples, the holes or openings within perforated metal (e.g., Ti) sheet structure may be created or drilled by lasers.

In certain examples, the supporting layer may include a porous metal fiber felt structure or a metallic sintered structure. For instance, in the case where the metal includes titanium, the titanium-based supporting layer may include a porous Ti fiber felt structure or Ti sintered structure.

The openings within the GDL supporting layer may have any particular shape, such as a hexagonal shape, a triangular shape, a round shape, or a parallelogrammatic shape, for example.

The porosity or size of each opening in the GDL supporting layer may also be configurable. For example, the diameter or length of each opening may be less than 0.05 mm, less than 0.1 mm, less than 0.2 mm, less than 0.5 mm, less than 1 mm, less than 2 mm, less than 5 mm, less than 10 mm, in a range of 0.01-10 mm, in a range of 0.05-5 mm, in a range of 0.1-2 mm, or in a range of 0.2-1 mm.

The thickness of the GDL supporting layer is also configurable based on the overall design or parameters of the electrochemical cell. For example, the GDL supporting layer may have a thickness of less than 10 microns, less than 25 microns, less than 50 microns, less than 100 microns, less than 250 microns, less than 500 microns, less than 1000 microns, in a range of 1-1000 microns, in a range of 5-500 microns, in a range of 10-250 microns, in a range of 10-100 microns, or in a range of 25-50 microns.

In certain examples, the GDL supporting layer may be configured to have segments that are open/perforated and other segments that are closed/non-perforated. This may be advantageous in optimizing the rigidity or strength needed for the supporting layer while also providing fluid transport through the layer. In other words, the non-open/non-perforated areas provide additional strength while the open/perforated areas provide the required fluid transport. The locations or positioning of the open/perforated areas and closed within the GDL supporting layer may be configured to aid in the optimization of fluid transport and distribution/equilibration of pressure across the GDL. For example, this may include positioning open areas or segments adjacent to channels of the cathode flow field and positioning closed/non-perforated areas or segments adjacent to lands of the flow field.

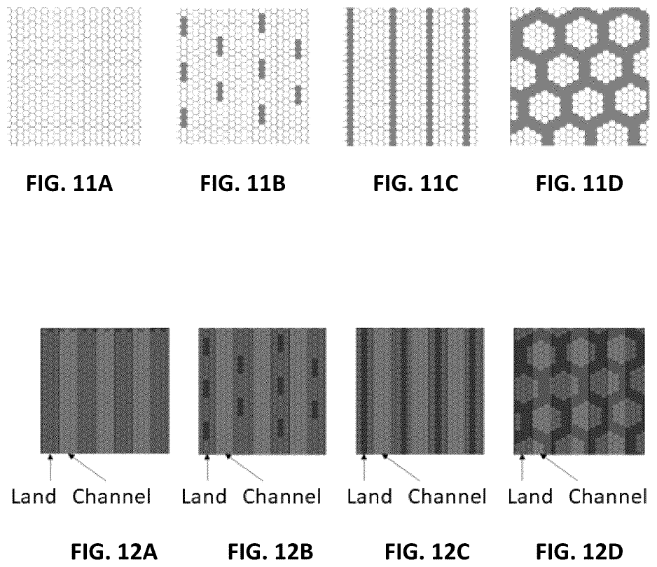

FIGS. 11A-11D depict non-limiting examples of various GDL supporting layer structures. In these examples, each of the openings has a hexagonal shape. For example, FIG. 11A depicts a GDL supporting structure full of hexagonal openings. FIGS. 11B-11D depict varying examples of a similar structure, but with various hexagonal segments of the structure being closed or non-perforated segments. FIG. 11B depicts only a few segments of spot welding, while FIG. 11C depicts a few lines of spot welding and FIG. 11D depicts hexagonal shaped areas of spot welding with openings in each center.

FIGS. 12A-12D depict non-limiting examples of the GDL supporting layer structures of FIGS. 11A-11D overlaid with the adjacent cathode flow field and the various lands and channels of the flow fields. In each case, the flow field includes four lands and three channels, where a channel is positioned between adjacent land segments of the flow field. As depicted in FIGS. 12B-12D, the land segments of the flow field may overlap with certain closed or non-perforated areas of the adjacent GDL supporting layer. As noted above, the positioning of these closed locations within the GDL supporting layer under the lands of the flow field may be configured to aid in optimizing the rigidity or strength needed for the GDL supporting layer while also providing two-phase fluid transport through the layer beneath the channels of the flow field.

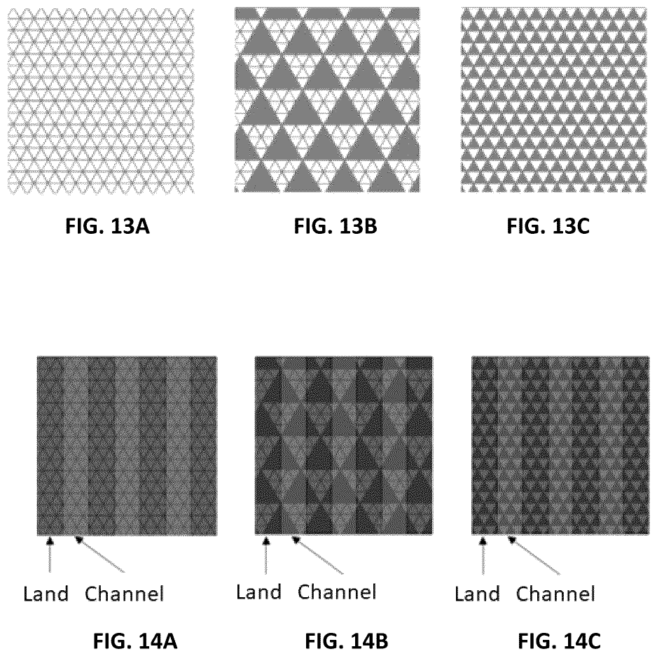

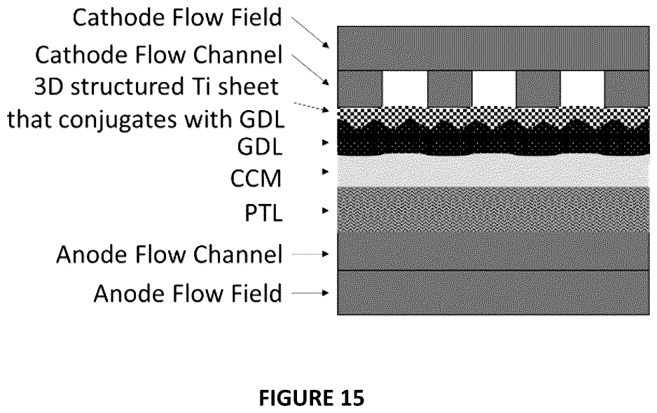

FIGS. 13A-13C depict additional non-limiting examples of various GDL supporting layer structures. In these examples, each of the openings has a triagonal shape. For example, FIG. 13A depicts a GDL supporting structure full of triagonal openings, while FIGS. 13B and 13C depict examples of a similar structure, but with various triagonal segments of the structure being closed or non-perforated segments. Specifically, FIG. 15B depicts larger triangular shapes of spot welding, while FIG. 15C depicts a similar design with smaller triangular shapes of spot welding.

FIGS. 14A-14C depict non-limiting examples of the GDL supporting layer structures of FIGS. 13A-13C overlaid with the adjacent cathode flow field and the various lands and channels of the flow fields. In each case, the flow field includes four lands and three channels, where a channel is positioned between adjacent land segments of the flow field. As depicted in FIGS. 14B and 14C, the land segments of the flow field may overlap with certain closed or non-perforated areas of the adjacent GDL supporting layer.

As a result of the reduced deformation of the GDL and CCM, pressure on the GDL may be more evenly distributed, current may be more evenly distributed, hydrogen crossover may be reduced, defects in the catalyst coating or GDL may be reduced (e.g., there is less localized deformation of the GDL areas positioned adjacent to a land of the cathode flow field), and/or the life/performance of the cell may be extended.

Further, in some examples, the addition of the GDL supporting layer to the electrochemical cell structure may allow for structure of the GDL itself to be reconfigured. For instance, due to the added strength and rigidity from the GDL supporting layer, the GDL itself may be reconfigured to have a greater porosity or higher spring constant to adsorb the tolerance of flatness for the different cell/stack components. In other words, while these design changes may reduce the stiffness or strength of the GDL, the adjacent GDL supporting layer makes up for these deficiencies.

Further, due to the addition of the GDL supporting layer (e.g., a Ti foil/sheet/felt/mesh layer), the GDL (e.g., carbon paper) may not require a certain density to provide a good conductivity, as the adjacent supporting layer assists in providing the required conductivity. Instead, the GDL may be configured to be more porous than a conventional GDL to allow for improved mass transfer.

In certain examples, the combination of the GDL supporting layer and GDL provide a similar thickness to the electrochemical cell structure in comparison to a cell only having the GDL. In other words, the addition of the GDL supporting layer may allow for a reduced thickness in the GDL itself, therein not adding to or increasing the overall thickness of the cell.

Additionally, in some examples, the addition of a GDL supporting layer to the electrochemical cell may be advantageous in redirecting fluid flow from the cathode flow field to the GDL and membrane. In other words, the supporting layer may restrict and/or redirect fluid flow to advantageously distribute the fluid more evenly across the entire active area. This concept is described in greater detail below with regard to potential reconfigurations of the flow field itself.

### 2. GDL Using 3-D Structured Supporting Layer

In another embodiment, an improved electrochemical cell or cell stack may be developed through an improved, reinforced gas diffusion layer (GDL) positioned between a cathode flow field plate and a membrane of a cell.

In this particular embodiment, similar to the examples discussed above, the GDL may be reinforced through the addition of a reinforcement layer on the cathode side of the electrochemical cell. This reinforcement or GDL supporting layer is similar to the examples discussed above, but the structure of the GDL supporting layer is slightly different. Specifically, the structure of the GDL supporting layer includes at least one surface having a three-dimensional (3D) shape. In other words, the surface of the GDL supporting layer is not flat or smooth. Instead, the surface is rough and may include protrusions extending outward toward the adjacent GDL.

Such a 3D shape may be provided via a metal wire mesh structure. For example, the metal wire mesh structure may be a titanium wire mesh structure. Such a structure may be formed with ends of wires protruding out from a base layer, extending in the direction of the adjacent GDL. In some cases, these wires may extend perpendicular to the GDL supporting layer.

FIG. 15 depicts an example of such an electrochemical cell having a 3D-structured GDL supporting layer providing reinforcement or support for an adjacent GDL. In this example, the electrochemical cell includes a cathode flow field, a GDL supporting layer, a GDL, a catalyst coated membrane (CCM), a PTL, and an anode flow field. The GDL supporting layer is positioned between the cathode flow field and GDL. As a result of the added rigidity and reinforcing support from the GDL supporting layer, deformation of the GDL and CCM may be reduced or minimized (as compared with the similar cell structure depicted in FIG. 9 that does not include the GDL supporting layer).

This non-smooth surface or 3D structured titanium sheet may be advantageous in allowing conjugation between the GDL supporting layer and the adjacent GDL (e.g., a carbon paper layer), therein minimizing electrical contact resistance between the two layers. For instance, during manufacturing and operation of the electrochemical cell, the GDL supporting layer and adjacent GDL are compressed together. The protruding metal (e.g., Ti) wires of the 3D-structured sheet compress against or protrude into the surface of the adjacent GDL (e.g., carbon paper), which advantageously creates better contact and conductivity between the two materials.

Additionally, similar to the embodiments discussed above, the 3D-structured GDL supporting layer may be advantageous in protecting the GDL from deformation during manufacturing or operation of the cell. Also, the 3D-structured GDL supporting layer may be advantageous in improving the uniformity of pressure distribution across the GDL. Further, the addition of a supporting or reinforcing layer may allow for the design or configuration of a less stiff or less dense GDL itself, as the supporting layer provides the required stiffness and strength to adsorb pressure from the adjacent layers such as the flow field lands.

The 3D-structured GDL supporting layer may be positioned between the cathode flow field and the GDL (as depicted in FIG. 15). In other examples, the 3D-structured GDL supporting layer may be positioned between the GDL and the membrane. In yet other examples, the 3D-structured GDL supporting layer may be sandwiched in between two separate GDL sheets, like a composite.

In certain examples, the 3D-structured GDL supporting layer may be adhered to one or both of the adjacent layers of the electrochemical cell. In other examples, the GDL supporting layer may be welded onto one or more land segments of the adjacent cathode flow field.

The openings within the 3D-structured GDL supporting layer may have any particular shape. In certain examples, the 3D-structure may have a honeycomb structure, which may be advantageous in improving the mechanical rigidity.

The porosity or size of each opening in the 3D-structured GDL supporting layer may also be configurable. For example, the diameter or length of each opening may be less than 0.05 mm, less than 0.1 mm, less than 0.2 mm, less than 0.5 mm, less than 1 mm, less than 2 mm, less than 5 mm, less than 10 mm, in a range of 0.01-10 mm, in a range of 0.05-5 mm, in a range of 0.1-2 mm, or in a range of 0.2-1 mm.

The thickness of the 3D-structured GDL supporting layer is also configurable based on the overall design or parameters of the electrochemical cell. For example, the 3D-structured GDL supporting layer may have a thickness of less than 10 microns, less than 25 microns, less than 50 microns, less than 100 microns, less than 250 microns, less than 500 microns, less than 1000 microns, in a range of 1-1000 microns, in a range of 5-500 microns, in a range of 10-250 microns, in a range of 10-100 microns, or in a range of 25-50 microns.

3. PTL with Supporting Layer

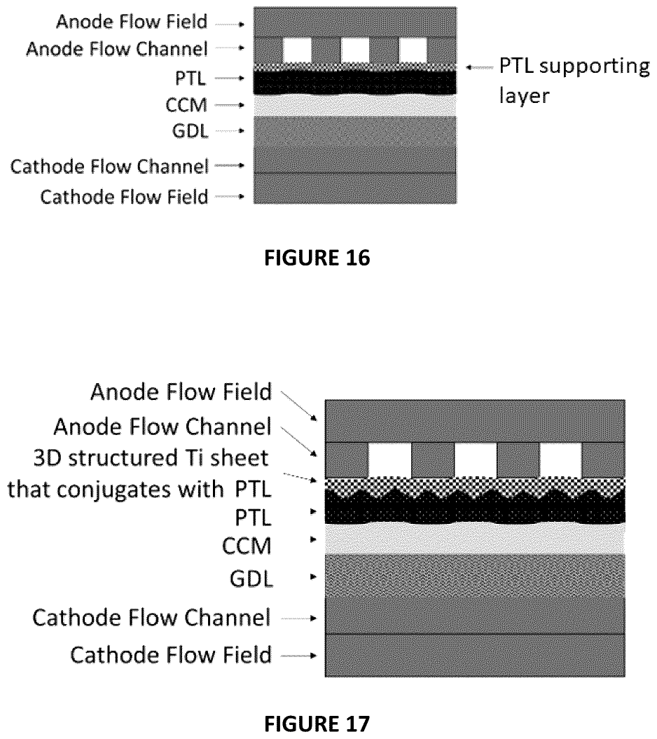

Alternatively, or additionally, to the examples discussed above, an improved electrochemical cell or cell stack may be provided with an improved, reinforced porous transport layer (PTL) that is positioned between the anode flow field plate and the membrane of the cell. FIG. 16 depicts an example of such an electrochemical cell having a PTL supporting layer providing reinforcement or support for an adjacent PTL. In this example, the electrochemical cell includes an anode flow field, a PTL supporting layer, a PTL, a catalyst coated membrane (CCM), a gas diffusion layer (GDL), and a cathode flow field. The PTL supporting layer is positioned between the anode flow field and PTL. As a result of the added rigidity and reinforcing support from the PTL supporting layer, deformation of the PTL and CCM may be reduced or minimized (as compared with the similar cell structure depicted in FIG. 9 that does not include any PTL supporting layer).

In this particular embodiment, the PTL may be reinforced through the addition of an additional reinforcement layer on the anode side of the electrochemical cell. This reinforcement layer may be a similar layer or composition as discussed above with relation to the GDL supporting layer or the 3D-structured GDL supporting layer.

Therefore, for similar reasons as a GDL supporting layer addition, the PTL supporting layer may be advantageous in protecting the PTL from deformation during manufacturing or operation of the cell. Additionally, the PTL supporting layer may be advantageous in improving the uniformity of pressure distribution across the PTL. Further, the addition of a supporting or PTL reinforcing layer may allow for the design or configuration of a less stiff or less dense PTL itself, as the supporting layer provides the required stiffness and strength to adsorb pressure from the adjacent layers such as the flow field lands. Another advantage may be that the geometry and configuration of the PTL supporting layer may assist in improving water flow distribution on the anode side of the cell. In yet another advantage, the PTL supporting layer may assist in improving current distribution on the anode side of the cell.

The reinforcement layer or PTL supporting layer may be positioned between the cathode flow field and the PTL (as depicted in FIG. 16). In other examples, the PTL supporting layer may be positioned between the PTL and the catalyst-coated membrane. In yet other examples, the PTL supporting layer may be sandwiched in between two separate PTL sheets, like a composite. Alternatively, the PTL may include fibers that may be manufactured or built around a reinforcing/PTL supporting Ti foil/mesh layer.

In certain examples, the PTL supporting layer may be adhered to one or both of the adjacent layers of the electrochemical cell. In other examples, the PTL supporting layer may be welded onto one or more land segments of the adjacent anode flow field.

The PTL supporting layer may be a metallic foil, sheet, felt, or mesh having perforations or openings within the layer to allow fluid flow toward or from the adjacent PTL. The metallic composition, in certain embodiments, may include titanium or titanium alloy.

In certain examples, the titanium-based supporting layer may include a porous Ti fiber felt structure or Ti sintered structure.

The openings within the PTL supporting layer may have any particular shape, such as a hexagonal shape, a triangular shape, a round shape, or a parallelogrammatic shape, for example.

The porosity or size of each opening in the PTL supporting layer may also be configurable. For example, the diameter or length of each opening may be less than 0.05 mm, less than 0.1 mm, less than 0.2 mm, less than 0.5 mm, less than 1 mm, less than 2 mm, less than 5 mm, less than 10 mm, in a range of 0.01-10 mm, in a range of 0.05-5 mm, in a range of 0.1-2 mm, or in a range of 0.2-1 mm.

The thickness of the PTL supporting layer is also configurable based on the overall design or parameters of the electrochemical cell. For example, the PTL supporting layer may have a thickness of less than 10 microns, less than 25 microns, less than 50 microns, less than 100 microns, less than 250 microns, less than 500 microns, less than 1000 microns, in a range of 1-1000 microns, in a range of 5-500 microns, in a range of 10-250 microns, in a range of 10-100 microns, or in a range of 25-50 microns.

In certain examples, the PTL supporting layer may be configured to have segments that are open/perforated and other segments that are closed/non-perforated. This may be advantageous in optimizing the rigidity or strength needed for the supporting layer while also providing fluid transport through the layer. In other words, the non-open/non-perforated areas provide additional strength while the open/perforated areas provide the required fluid transport. The locations or positioning of the open/perforated areas and closed within the PTL supporting layer may be configured to aid in the optimization of fluid transport and distribution/equilibration of pressure across the PTL. For example, this may include positioning open areas or segments adjacent to channels of the cathode flow field and positioning closed/non-perforated areas or segments adjacent to lands of the flow field.

The examples discussed with relation to the GDL supporting layer may be applicable here for the PTL supporting layer. Specifically, the GDL supporting layer structures depicted in FIGS. 11A-11D, FIGS. 12A-12D, FIGS. 13A-13C, and FIGS. 14A-14C may be applied to a PTL supporting layer as well.

As a result of the reduced deformation of the PTL and CCM by the addition of the PTL supporting layer, pressure on the PTL may be more evenly distributed, current may be more evenly distributed, defects in the catalyst coating or PTL may be reduced (e.g., there is less localized deformation of the PTL areas positioned adjacent to a land of the anode flow field), and/or the life/performance of the cell may be extended.

Further, in some examples, the addition of the PTL supporting layer to the electrochemical cell structure may allow for structure of the PTL itself to be reconfigured or redesigned. For instance, due to the added strength and rigidity from the PTL supporting layer, the PTL itself may be reconfigured to have a greater porosity or higher spring constant to adsorb the tolerance of flatness for the different cell/stack components. In other words, while these design changes may reduce the stiffness or strength of the PTL, the adjacent PTL supporting layer makes up for these deficiencies.

Further, due to the addition of the PTL supporting layer (e.g., a Ti foil/sheet/felt/mesh layer), the PTL may not require a certain density to provide a good conductivity, as the adjacent supporting layer assists in providing the required conductivity. Instead, the PTL may be configured to be more porous than a conventional PTL to allow for improved mass transfer.

In certain examples, the combination of the PTL supporting layer and PTL provide a similar thickness to the electrochemical cell structure in comparison to a cell only having the PTL. In other words, the addition of the PTL supporting layer may allow for a reduced thickness in the PTL itself, therein not adding to or increasing the overall thickness of the cell.

Additionally, in some examples, the addition of a PTL supporting layer to the electrochemical cell may be advantageous in redirecting fluid flow from the anode flow field to the PTL and membrane. In other words, the supporting layer may restrict and/or redirect fluid flow to advantageously distribute the fluid more evenly across the entire active area. This concept is described in greater detail below with regard to potential reconfigurations of the flow field itself.

As noted above, in certain examples, the PTL supporting layer may include at least one surface having a three-dimensional (3D) shape. In other words, the surface of the PTL supporting layer is not flat or smooth. Instead, the surface is rough and may include protrusions extending outward toward the adjacent PTL.

Similar to the 3D-structured GDL supporting layer discussed above, the 3D shape of the PTL supporting layer may be provided via a metal wire mesh structure. For example, the metal wire mesh structure may be a titanium wire mesh structure. Such a structure may be formed with ends of wires protruding out from a base layer, extending in the direction of the adjacent GDL. In some cases, these wires may extend perpendicular to the GDL supporting layer.

FIG. 17 depicts an example of such an electrochemical cell having a 3D-structured PTL supporting layer providing reinforcement or support for an adjacent PTL. In this example, the electrochemical cell includes a cathode flow field, a GDL, a catalyst coated membrane (CCM), a PTL, a 3D-structured PTL supporting layer, and an anode flow field. The PTL supporting layer is positioned between the anode flow field and PTL. As a result of the added rigidity and reinforcing support from the PTL supporting layer, deformation of the PTL and CCM may be reduced or minimized (as compared with the similar cell structure depicted in FIG. 9 that does not include the PTL supporting layer).

This non-smooth surface or 3D structured titanium sheet may be advantageous in allowing conjugation between the PTL supporting layer and the adjacent PTL (e.g., a carbon paper layer), therein minimizing electrical contact resistance between the two layers. For instance, during manufacturing and operation of the electrochemical cell, the PTL supporting layer and adjacent PTL are compressed together. The protruding metal (e.g., Ti) wires of the 3D-structured sheet compress against or protrude into the surface of the adjacent PTL, which advantageously creates better contact and conductivity between the two materials.

Additionally, similar to the embodiments discussed above, the 3D-structured PTL supporting layer may be advantageous for similar reasons.

The 3D-structured PTL supporting layer may be positioned between the anode flow field and the PTL (as depicted in FIG. 17). In other examples, the 3D-structured PTL supporting layer may be positioned between the PTL and the membrane. In yet other examples, the 3D-structured PTL supporting layer may be sandwiched in between two separate PTL sheets, like a composite.

In certain examples, the 3D-structured PTL supporting layer may be adhered to one or both of the adjacent layers of the electrochemical cell. In other examples, the PTL supporting layer may be welded onto one or more land segments of the adjacent anode flow field.

The openings within the 3D-structured PTL supporting layer may have any particular shape. In certain examples, the 3D-structure may have a honeycomb structure, which may be advantageous in improving the mechanical rigidity.

The porosity or size of each opening in the 3D-structured PTL supporting layer may also be configurable. For example, the diameter or length of each opening may be less than 0.05 mm, less than 0.1 mm, less than 0.2 mm, less than 0.5 mm, less than 1 mm, less than 2 mm, less than 5 mm, less than 10 mm, in a range of 0.01-10 mm, in a range of 0.05-5 mm, in a range of 0.1-2 mm, or in a range of 0.2-1 mm.

The thickness of the 3D-structured PTL supporting layer is also configurable based on the overall design or parameters of the electrochemical cell. For example, the 3D-structured PTL supporting layer may have a thickness of less than 10 microns, less than 25 microns, less than 50 microns, less than 100 microns, less than 250 microns, less than 500 microns, less than 1000 microns, in a range of 1-1000 microns, in a range of 5-500 microns, in a range of 10-250 microns, in a range of 10-100 microns, or in a range of 25-50 microns.

### 4. Self-Reinforced GDL

In another example, an improved electrochemical cell or cell stack may be developed through a self-reinforced gas diffusion layer (GDL) positioned between a cathode flow field plate and a membrane of a cell.

In this particular embodiment, no additional supporting layer is added to reinforce the GDL. Instead, the GDL itself is reconfigured to provide the needed support to protect the GDL or adjacent membrane layer from deformation during manufacturing or operation of the cell.

Such a self-reinforced GDL may provide similar advantages to those discussed above for the added GDL supporting layer (e.g., improving pressure distribution, improving current distribution, improving fluid flow distribution, reducing deformation).

In one example, the self-reinforced GDL may include a composite of carbon fiber and carbon paper. The carbon fiber may be arranged in a pattern or structure to improve the mechanical rigidity of the carbon paper in the GDL composition. In certain examples, the pattern or structure of the carbon fiber may be a honeycomb or hexagonal structure. Other patterns or structural arrangements of carbon fibers are also possible, as long as they provide an added rigidity to the overall composition of the GDL (in comparison to a similar GDL without the carbon fiber structural arrangement), therein providing the needed structural support for the carbon paper within the layer.

In this particular example, the self-reinforced GDL having carbon fiber and carbon paper may be formed by first providing a carbon fiber composition or sublayer and forming patterns within the carbon fiber sublayer. For example, a hexagonal or honeycomb pattern may be designed within a roller or stamp. The patterned roller/stamp may be applied to the carbon fiber sublayer to imprint such a pattern within the sublayer. Following this patterned sublayer formation, the sublayer may be heated to thermally treat the pattern and provide a sublayer with improved rigidity. In certain examples, this thermal treatment process may involve heating the sublayer to a temperature in a range of 800 °C to 1100 °C. Following the thermal treatment of the carbon fiber sublayer, carbon paper may be added as an additional sublayer to the GDL to provide an overall GDL structure having an improved rigidity, as well as additional advantageous performance properties (e.g., improved pressure distribution, improved current distribution, improved fluid flow distribution, reduced deformation) over a comparable GDL structure without the added patterned/thermally treated carbon fiber sublayer.

In an alternative example, the self-reinforced GDL may include a combination composition of a metal mesh or metal fiber felt and carbon fiber or carbon paper. In some examples, the metal mesh/fiber is arranged in a pattern or structure to improve the mechanical rigidity of the carbon fiber/paper in the GDL composition. Alternatively, or additionally, the metal mesh/fiber may be embedded within the carbon fiber/paper to improve the rigidity.

In certain examples, such as those discussed above with relation to the added supporting layer, the metal mesh or fiber felt may include a titanium mesh or fiber felt composition.

The pattern or structure of the metal mesh or fiber felt may be a hexagonal or honeycomb structure. Other patterns or structural arrangements of carbon fibers are also possible, as long as they provide an added rigidity to the overall composition of the GDL to provide the needed structural support for the carbon paper within the layer.

In these examples, the self-reinforced GDL having the metal (e.g., Ti) mesh/fiber and carbon fiber/paper may be formed by first providing the metal mesh/fiber felt as a skeleton sublayer. In some examples, a hexagonal or honeycomb pattern may be applied to the metal mesh/fiber felt sublayer via a roller or stamp to imprint the pattern within the sublayer.

Following the providing of the metal mesh/fiber felt sublayer (and optional imprinting of a pattern), the metal mesh/fiber felt composition may be embedded within carbon fibers or carbon paper. Subsequently, the combined compositions may be heated to thermally treat the pattern and provide a GDL with improved rigidity, as well as additional advantageous performance properties (e.g., improved pressure distribution, improved current distribution, improved fluid flow distribution, reduced deformation) over a comparable GDL structure without the added metal (e.g., Ti) mesh/fiber composition. In certain examples, this thermal treatment process may involve heating the combined compositions to a temperature in a range of 800 °C to 1100 °C.

### 5. Self-Reinforced PTL

In another example, an improved electrochemical cell or cell stack may be developed through a self-reinforced porous transport layer (PTL) positioned between the anode flow field plate and a membrane of the cell.

In this particular embodiment, no additional supporting layer is added to reinforce the PTL. Instead, the PTL itself is reconfigured to provide the needed support to protect the PTL or adjacent membrane layer from deformation during manufacturing or operation of the cell.

Such a self-reinforced PTL may provide similar advantages to those discussed above for the added PTL supporting layer (e.g., improving pressure distribution, improving current distribution, improving fluid flow distribution, reducing deformation).

In one example, the self-reinforced PTL may include a first porous metal mesh/fiber felt sublayer and a second porous metal mesh/fiber felt sublayer, wherein the first sublayer is arranged in a pattern or structure to improve the mechanical rigidity of the second sublayer and overall PTL. In certain examples, the first and/or second porous metal mesh/fiber felt sublayers include a titanium mesh/fiber felt composition. The pattern or structure of the first sublayer of metal (e.g., Ti) mesh/fiber felt may be a honeycomb or hexagonal structure. Other patterns or structural arrangements are also possible, as long as they provide an added rigidity to the overall composition of the PTL (in comparison to a similar PTL without the structural arrangement).

The self-reinforced PTL may be formed by providing a sublayer of unsintered or green state of porous titanium. The green state composition may then be modified by imprinting a pattern onto a surface of the composition. For example, a hexagonal or honeycomb pattern may be applied within a roller or stamp to a surface of the unsintered composition. The modified green state layer with the hexagonal or honeycomb structure may then be pressed onto a sublayer of titanium mesh. Subsequently, the combined sublayers may be sintered or heated to thermally treat the combined sublayers to provide the PTL within improved rigidity and additional advantageous performance properties, as mentioned above.

Alternatively, the self-reinforced PTL may be formed by slurry tape casting an unsintered or green state sublayer of porous titanium onto an expanded sublayer of titanium mesh. The combined sublayers may then be modified by imprinting a pattern (e.g., hexagonal or honeycomb) onto a surface of the green state sublayer of titanium. The modified structure may then be sintered or heated to thermally treat the combined sublayers to provide the PTL within improved rigidity and additional advantageous performance properties, as mentioned above.

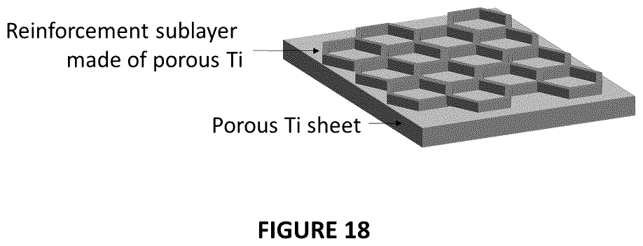

FIG. 18 depicts such an example of a self-reinforced PTL. In this example, the PTL includes a sublayer of porous titanium mesh and a sublayer of porous titanium having a patterned hexagonal/honeycomb structure to provide the added rigidity for the PTL.

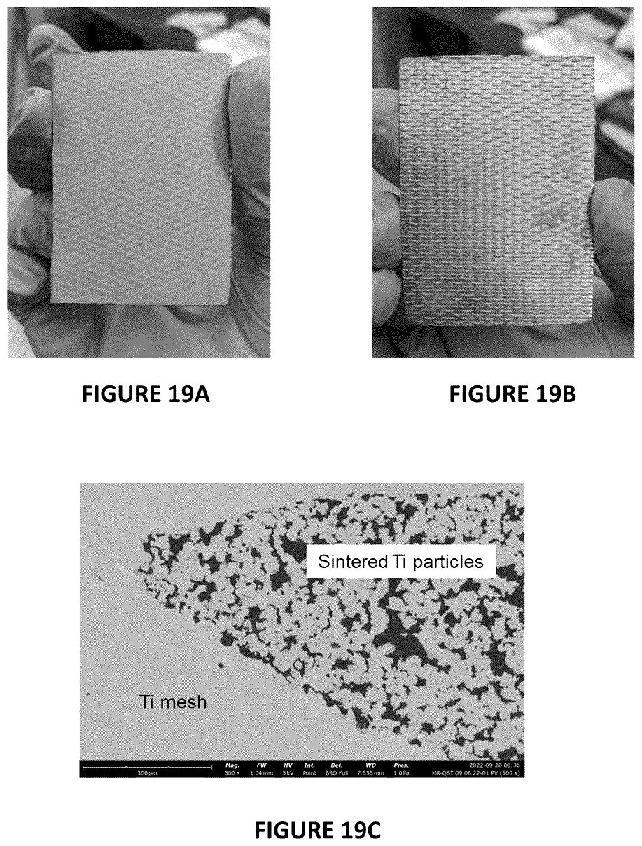

FIGS. 19A-19C depict an additional example of a self-reinforced PTL that includes a tape casted titanium mesh composition integrated with a PTL. FIG. 19A depicts the tape cast side of the self-reinforced PTL that has been sintered. FIG. 19B depicts the opposite sintered side of the self-reinforced PTL. FIG. 19C depicts a plan-view (top view) cross-section of such a composition, showing a dense Ti mesh area and mesh opening filled with Ti particles.

6. Flow Field Designs—Uniform Pressure and/or Water Distribution

In additional examples, an improved electrochemical cell or cell stack may be provided via a modified cathode and/or anode flow field. In this particular embodiment, instead of or in addition to adding a GDL or PTL supporting layer, the electrode flow field itself may be reconfigured to improve pressure distribution across the GDL or PTL.

For example, one or more supporting layers may be added to or incorporated within one or more open areas of respective flow field channels. These flow field supporting layer(s) may be incorporated into the flow field design by welding one or more perforated sheets or layers onto a parallel-path flow field. The flow field supporting layer(s) incorporated into the flow field may be made of a similar support structure material as discussed above. For instance, the flow field supporting layer may be a perforated metal foil or sheet, e.g., a perforated titanium foil or sheet. Alternatively, a metal (e.g., Ti) block may be machined to create the flow field supporting layer openings within the channels of a flow field.

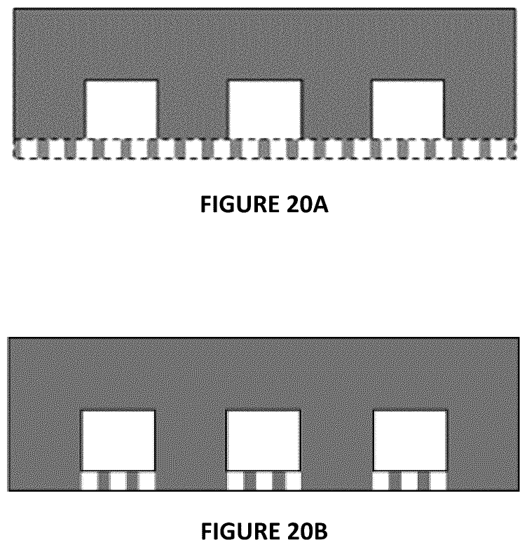

FIGS. 20A and 20B depict contrasting examples of supporting layer configurations for providing an electrochemical cell with improved performance properties such as improved, more uniform pressure distribution across the adjacent GDL or PTL. FIG. 20A depicts an example of an electrode (e.g., cathode or anode) flow field and an adjacent GDL or PTL supporting layer, such as the examples discussed above.

FIG. 20B depicts an alternative approach having flow field supporting segments or flow field supporting layers incorporated within the flow field itself.

The approaches of having an adjacent GDL or PTL supporting layer or incorporating the supporting material into the flow field design may be advantageous in providing improved pressure and/or water distribution due to the added restrictions for fluid flow within the channels of the flow fields, wherein fluid flow is redirected into and out of the channels. Due to this redirection or redistribution, pressure and/or water on the adjacent GDL or PTL may be more evenly distributed. This leads to additional performance advantages within the electrochemical cell such as extended life of the cell, improved current distribution, or reduced deformation of the GDL/PTL and/or membrane, for example.

Additionally, through the addition of the flow field supporting layer or material to the flow field itself, this may further be advantageous in providing an improved electrochemical cell without adding any additional thickness to the cell due to an added supporting layer.

In certain examples, the thickness of the flow field supporting layer within the openings or flow field channels as shown in FIG. 20B may be at least 100 microns, at least 200 microns, at least 500 microns, at least 1000 microns, at least 2000 microns, at least 5000 microns, in a range of 100-5000 microns, in a range of 200-2000 microns, or in a range of 500-1000 microns.

The perforations or openings within the flow field supporting layer may be any type of size, design, shape, or location that assists in redistributing pressure across the adjacent GDL or PTL. For instance, the shape of each opening may be a hexagonal shape, a triangular shape, a round shape, or a parallelogrammatic shape, for example.

The porosity or size of each opening in the flow field supporting layer may also be configurable. For example, the diameter or length of each opening may be less than 0.05 mm, less than 0.1 mm, less than 0.2 mm, less than 0.5 mm, less than 1 mm, less than 2 mm, less than 5 mm, less than 10 mm, in a range of 0.01-10 mm, in a range of 0.05-5 mm, in a range of 0.1-2 mm, or in a range of 0.2-1 mm.

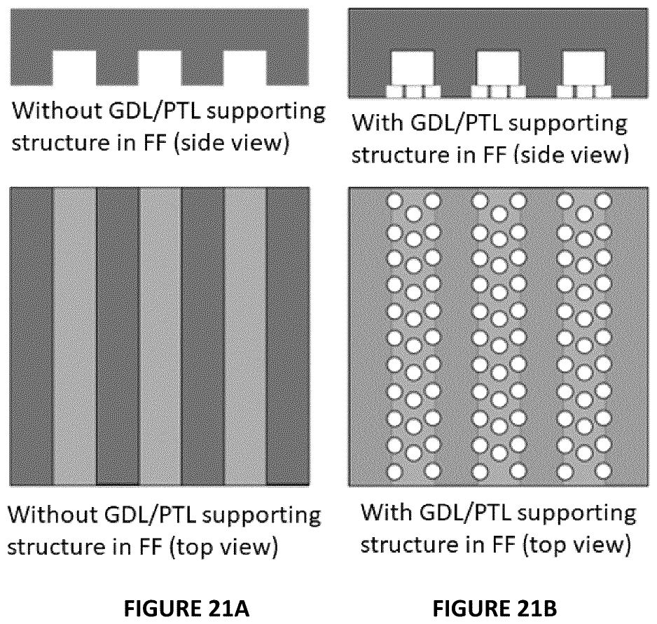

FIGS. 21A and 21B depict additional comparative examples that highlight the addition of a flow field supporting layer. Specifically, FIG. 21A depicts a side view and a top view of an example of an electrode (e.g., cathode or anode) flow field without any added flow field supporting layer. FIG. 21B depicts a side view and a top view of an example of an electrode (e.g., cathode or anode) flow field having flow field supporting segments or flow field supporting layers incorporated within the flow field itself. As shown in the side view of FIG. 21B, the flow field supporting layer includes multiple openings at the base of each channel of the flow field. In this example, certain openings in the flow field supporting layer extend beyond the edge of the respective channel opening, therein extending or cutting into the adjacent land of the flow field channel. As shown in the top view of FIG. 21B, the flow field supporting layer includes a plurality of circular openings, primarily positioned within the channels of the flow field. As noted above, alternative sizes, shapes, and opening patterns are possible.

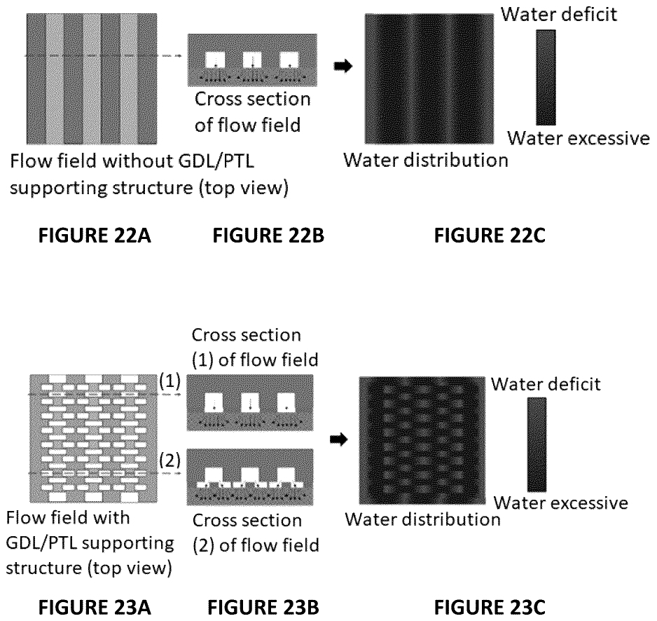

FIGS. 22A-22C and FIGS. 23A-23C depict additional comparative examples that highlight the addition of a flow field supporting layer. Specifically, FIGS. 22A-22C relates to an example of a flow field without any added flow field supporting layer. FIG. 22A depicts a top view of the flow field and FIG. 22B depicts a cross-sectional view of FIG. 22A along the dashed line. Within FIG. 22B, an exemplary flow of fluid (e.g., water) is shown out of the three channels in the flow field. As shown in the example, the water flow is concentrated directly beneath each of the channels. FIG. 22C provides an exemplary “top view” depiction of the water flow or distribution that correlates with the flow field depicted in FIG. 22A. As shown in this water flow distribution image, little to no water flow (i.e., a water deficit) is expected in certain segments beneath the lands of the flow field, such as on the far edges of the outer two lands as well as the center areas between the internal two lands. Additionally, water distribution is excessive beneath the three channels, which correlates with the depiction in FIG. 22B.

In contrast to FIGS. 22A-22C, FIGS. 23A-23C depict an example of an electrode (e.g., anode or cathode) flow field having an added flow field supporting layer. FIG. 23A depicts a top view of the flow field with the supporting layer structure. In this example, the openings or perforations in the flow field supporting layer are rectangular in shape. Certain perforations or openings are positioned within a channel of the flow field, while other perforations or openings are partially positioned within a channel and within an adjacent land of the flow field.

FIG. 23B depicts cross-sectional views of two segments of FIG. 23A along the dashed lines. In the first segment, the cross-sectional view relates to a section of the flow field wherein the openings or perforations of the flow field supporting layer are positioned within the channel of the flow field. As such, the flow of fluid (e.g., water) out of the channels of three channels of the flow field is similar to the fluid flow depicted in FIG. 22B. In other words, the water flow is concentrated directly beneath each of the channels, as the openings/perforations in this area are similar to an example having no flow field supporting segment at all. In contrast, in the second cross-sectional view of FIG. 23B, the cross-sectional view relates to a section of the flow field wherein the openings or perforations of the flow field supporting layer overlap with the channel and with an adjacent land of the flow field. As such, the flow of fluid (e.g., water) out of the channels of three channels of the flow field is restricted, wherein a portion of the water is redirected toward areas underneath the lands. In other words, the water flow is better distributed in this area of the flow field due to the added restrictions/perforations in the flow field supporting layer.

FIG. 23C provides an exemplary “top view” depiction of the water flow or distribution that correlates with the flow field depicted in FIG. 23A. As shown in this water flow distribution image, little to no water flow (i.e., a water deficit) is expected in minimal areas segments beneath the lands of the flow field, such as on the far edges of the outer two lands as well as within minimal segments of the center areas between the internal two lands. Additionally, water distribution is excessive beneath the three channels as well as within added areas beneath the lands, which correlates with the depictions in FIG. 23B. In comparison with the water distribution in a flow field without the added supporting structure (see FIG. 22C), the water distribution in FIG. 23C is more uniform, providing fewer areas or segments having a water deficit.

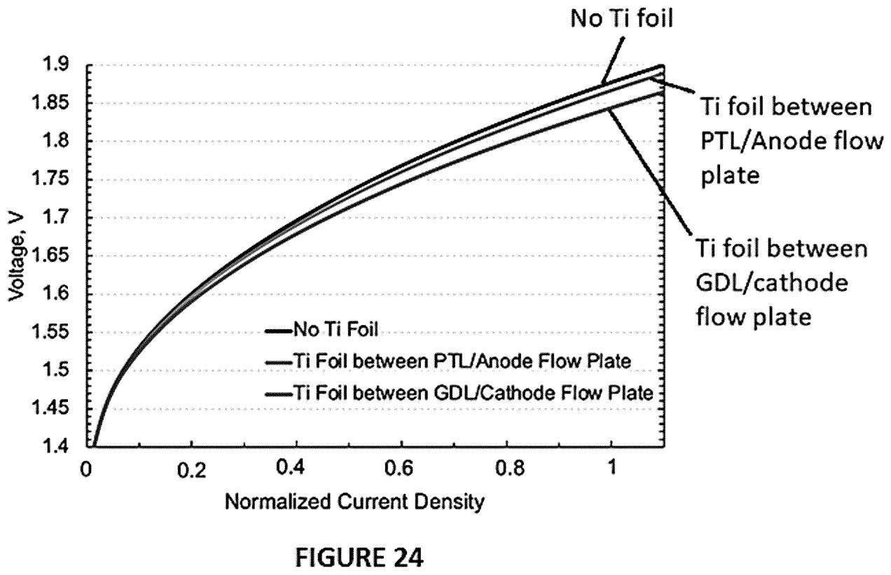

FIG. 24 depicts an example showing the impact on electrolyzer cell performance via the addition of a supporting layer (e.g., Ti foil or Ti mesh) to support the PTL or GDL. Specifically, FIG. 24 compares simulated polarization curves for three cases: (1) an example in which there is no supporting layer within the electrochemical cell; (2) a Ti foil/mesh supporting layer within the cell that is positioned between a Ti-based PTL and anode flow plate; and (3) a Ti foil/mesh supporting layer within the cell that is positioned between a porous carbon based GDL and cathode flow plate. As shown within the figure, the addition of a PTL supporting layer to the cell provides an improvement in cell performance of 10 mV in comparison to a cell having no supporting layer at a normalized current density of 1. Further, the addition of a GDL supporting layer provides an improvement in cell performance of 40 mV in comparison to a cell having no supporting layer at a normalized current density of 1. The improved cell performance is higher for the GDL supporting layer example, because electron conductivity of carbon based GDL is lower than titanium PTL. Uniform current distribution is also important for maximizing catalyst utilization.

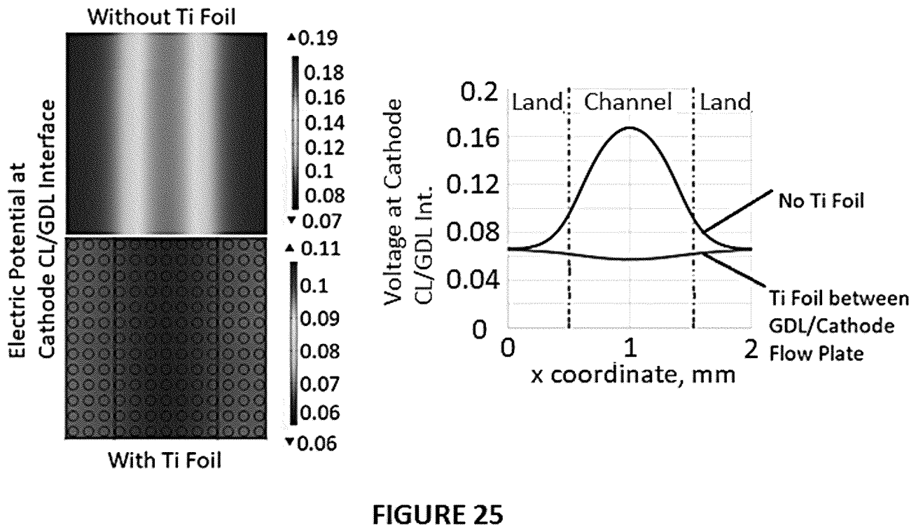

FIG. 25 depicts a comparison of the uniformity in voltage (or current) at the cathode catalyst layer/GDL interface between an electrochemical cell having a supporting layer (i.e., Ti foil/mesh supporting layer) added between the GDL and cathode flow plate and a similar electrochemical cell without such a supporting layer.

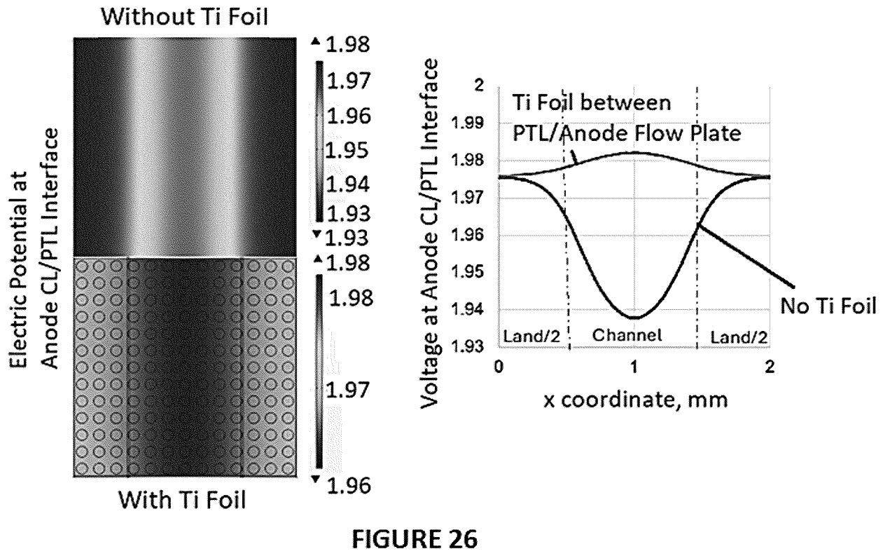

FIG. 26 depicts a comparison of the uniformity in voltage (or current) at the anode catalyst layer/PTL interface between an electrochemical cell having a supporting layer (i.e., Ti foil/mesh supporting layer) added between the PTL and anode flow plate and a similar electrochemical cell without such a supporting layer.

In both examples within FIGS. 25 and 26, the addition of the Ti foil/mesh supporting layer advantageously increases the lateral current along the channel spans, which increases catalyst utilization in the middle of the channels.

Further, in addition to better electron conduction, less ohmic losses and improved current spreading, the addition of a Ti foil/mesh supporting layer also provides a good mechanical support in particular in cathode side where a more compliant diffusion layer is used, e.g., carbon GDL. Compliant GDLs pillow into channel spans. This pillowing results in stretching the catalyst layer resulting in a discontinuity in electron transport between catalyst particles. The Ti foil supporting layer advantageously reduces pillowing of GDL into channels and reduces stretching in the catalyst layer, mitigating a discontinuity in electron transport between catalyst particles due to pillowing.

### EXAMPLES

### Example 1—Ti Mesh Supporting Layer Added Between GDL and Cathode Flow Plate

Titanium mesh was tested as a support material between the cathode flow field and the gas diffusion layer (GDL). First, four cells were built to test the effect of titanium mesh on the pressure distribution in the cell from the flow field lands to the active area. Next, 21 cells were built to evaluate titanium mesh for prevention of short circuiting the cell during assembly. Lastly, two cells were built to demonstrate the effect of titanium mesh on cell efficiency.

To evaluate the effect on pressure distribution in the cell, four cells were built with pressure paper included between the GDL and the CCM. Of the four cells, two were built using cross-pattern flow fields, in which one cell had titanium mesh and the other did not; and the two other cells were built using parallel-pattern flow fields, in which one cell had titanium mesh and the other did not. Each cell was torqued to reach the same average active area pressure.

Table 1 summarizes the cumulative percent (%) of area, i.e., the percentage of the active area that experienced pressures above a given threshold for each cell. From this data, it was shown that the inclusion of titanium mesh improves the cumulative (%) of area in the cell. A higher cumulative % of area is indicative of better contact between the GDL and the cathode catalyst layer, which in turn leads to better through-plane and in-plane conductivity, and ultimately, better cell efficiency.

TABLE 1
Cumulative % of area experiencing pressures above
a given threshold in four cell configurations)

| | Without Titanium | With Titanium |
|---|---|---|
| | Mesh | Mesh |
| Cross Pattern Flow Field | 63.2% of area | 100% of area |
| Parallel Pattern Flow Field | 52.8% of area | 96.0% of area |

These results show that the addition of a GDL supporting layer provides improved uniformity of the pressure distribution within the active area. Additionally, because contact area and current distribution are positively correlated, the results also show that the addition of a GDL supporting layer provides improved current distribution within the cell.

To evaluate the effect of short-circuiting prevention, 21 cells were built. Ten (10) cells were built without titanium mesh, and eleven (11) were built with titanium mesh between the cathode flow field and the GDL. These cells were torqued to significantly higher compressions in order to induce short circuiting at an elevated rate such that component effects on short circuiting would be apparent. In these tests, 40% of cells without titanium mesh short circuited, while only 27% of cells with titanium mesh short circuited. In other words, the addition of a supporting layer may advantageously prevent or reduce the chance of short circuiting within the electrochemical cell.

Finally, the effect of titanium mesh on the electrochemical efficiency of an electrolysis cell was tested via a standard polarization test. In this test, two cells that were identical in components and assembly except for the presence of titanium mesh in one cell and not the second cell were subjected to increasing current densities up to a maximum current density. At the maximum current density, the overpotential of the cell containing the titanium mesh was 2.3% lower than that of the cell without the titanium mesh reinforcement layer. This result supports that the addition of a supporting layer improves the electrochemical efficiency of the cell. For example, the supporting layer may provide an improvement of pressure distribution across the GDL, an improvement of current distribution across GDL, an improvement of fluid distribution within the electrochemical cell, and/or reduced defects in a catalyst coating on the membrane.

### Example 2—Ti Mesh Supporting Layer Added Between PTL and Anode Flow Plate

In order to test the efficacy of titanium mesh as a support for the PTL, a Ti mesh was placed in contact with the anode flow field on one side and a PTL on the other side. Altogether, the components were placed into an electrochemical cell with pressure paper contacting the PTL and GDL. Four different cells were built to evaluate the impact of using a titanium mesh on the anode side: two cells were built using cross-pattern flow fields, in which one cell had titanium mesh and the other did not; and two other cells were built using parallel-pattern flow fields, wherein one cell used titanium mesh and the other did not. Each cell was torqued to reach the same GDL compression.

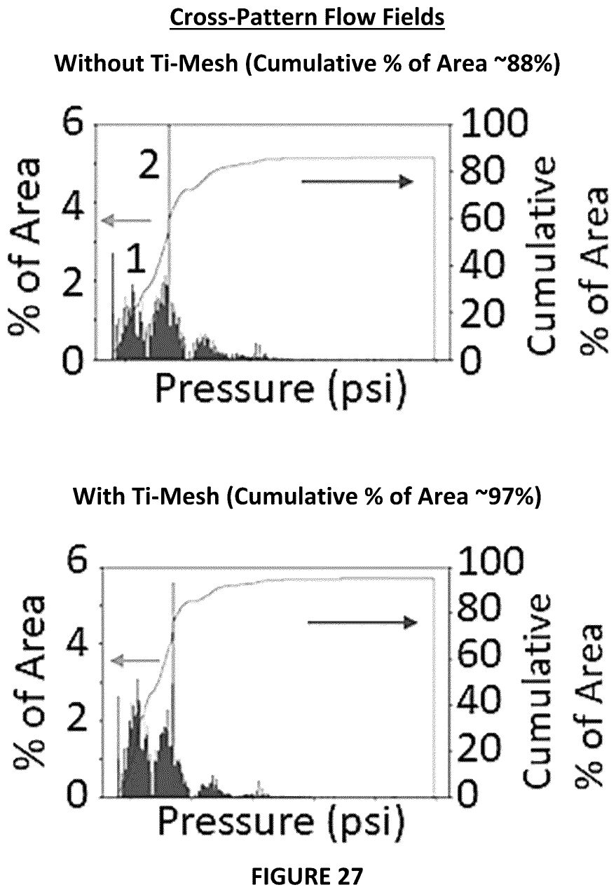

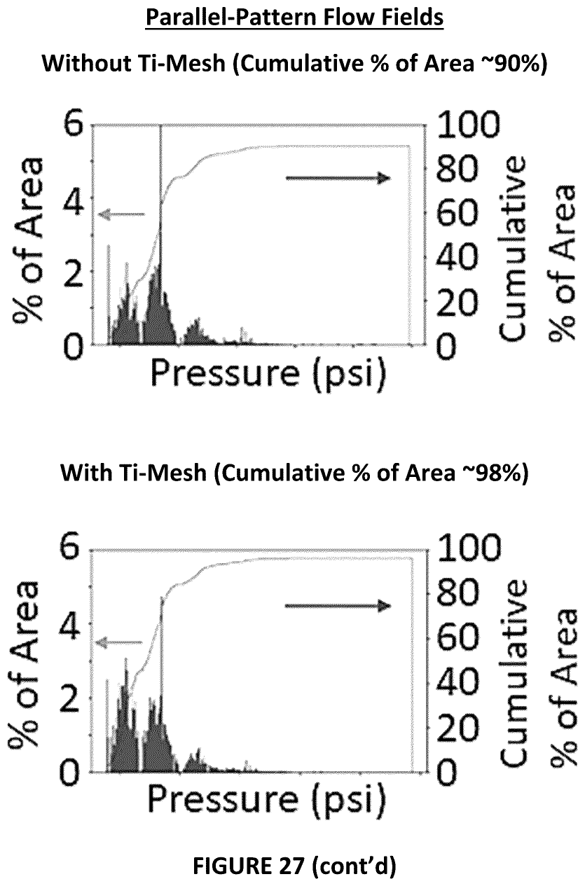

FIG. 27 depicts examples of the impact of a Ti mesh supporting layer on the distribution of pressure on an active area of an electrochemical cell. In FIG. 27, the “% Area” describes the contribution of each pressure to the contact measured in the 2-D area, while the “Cumulative % of Area” describes the cumulative sum of the % of Area as a function of the measured pressure in the 2-D area. For both types of cells built, cross-pattern or parallel-pattern, the “Cumulative % of Area” increases with the use of Ti mesh as a support on the anode side. This means that when implemented in a cell, the catalyst coated membrane (CCM) will attain better contact with the PTL/GDL components when the supporting layer is added. The histograms showing the “% of Area” also illustrate the benefits of using Ti mesh as an anode support, specifically by looking at the first two peaks of the histogram (as shown in the image). For both types of cells built, there was an increase in the “% of Area” for the first peak (lowest pressure peak) and there was a decrease in the second peak when using a Ti mesh as opposed to without one. This means that pressure is positively redistributed using a Ti mesh supporting layer to permit pressure in channel regions that previously attained zero pressure.

These results show that the addition of a PTL supporting layer may provide improved uniformity of the pressure distribution within the active area. Additionally, because contact area and current distribution are positively correlated, the results also show that the addition of a PTL supporting layer provides improved current distribution within the cell.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

As used herein, the singular forms “a,” “an,” and “the” include plural referents unless the context clearly dictates otherwise.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

The Abstract of the Disclosure is provided to comply with 37 C.F.R. § 1.72 (b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the disclosure. The claims should not be read as limited to the described order or elements unless stated to that effect. Therefore, all embodiments that come within the scope and spirit of the following claims and equivalents thereto are claimed as the disclosure.

1. An electrochemical cell comprising:
an electrode having a flow field;
a membrane;
a porous transport layer (PTL) or gas diffusion layer (GDL) positioned between the flow field and the membrane; and
a supporting layer positioned between the flow field and the PTL or the GDL,
wherein the supporting layer is configured to reduce localized deformation on the PTL or the GDL, reduce or prevent short circuiting of the electrochemical cell, improve electrochemical efficiency of the electrochemical cell, improve pressure distribution across the PTL or the GDL, improve current distribution across the PTL or the GDL, improve fluid distribution within the electrochemical cell, reduce defects in a catalyst coating on the membrane, and/or extend a life of the electrochemical cell in comparison with a similar electrochemical cell not having the supporting layer.

2. (canceled)

3. The electrochemical cell of claim 1, wherein the supporting layer is welded onto land segments of the flow field.

4.-5. (canceled)

6. The electrochemical cell of claim 1, wherein the supporting layer comprises a metallic foil, sheet, felt, or mesh.

7. The electrochemical cell of claim 6, wherein the metallic foil, sheet, felt, or mesh comprises titanium, titanium alloys, niobium, niobium alloys, tantalum, tantalum alloys, or stainless steel.

8. The electrochemical cell of claim 6, wherein the metallic foil, sheet, felt, or mesh has a surface coating comprising platinum, gold, niobium, metal nitride, metal carbide, or metal oxide.

9. The electrochemical cell of claim 1, wherein the supporting layer comprises perforations or openings within the supporting layer configured to allow fluid flow toward or from the PTL or the GDL.

10. The electrochemical cell of claim 9, wherein the perforations or the openings within the supporting layer have hexagonal shapes, triangular shapes, round shapes, parallelogrammatic shapes, or a combination thereof.

11. The electrochemical cell of claim 1, wherein the supporting layer is perforated within certain segments less than all of the supporting layer, and
wherein the supporting layer comprises non-perforated segments in remaining segments of the supporting layer.

12. The electrochemical cell of claim 11, wherein one or more of the perforated segments of the supporting layer is positioned adjacent to one or more channels of the flow field of the electrode, and
wherein one or more of the non-perforated segments of the supporting layer is positioned adjacent to one or more lands of the flow field of the electrode.

13. (canceled)

14. The electrochemical cell of claim 1, wherein the electrode is a cathode, and
wherein the supporting layer is positioned between the flow field of the cathode and the GDL.

15. The electrochemical cell of claim 14, wherein the GDL comprises carbon paper, carbon fiber felt, carbon cloth, or a combination thereof.

16. The electrochemical cell of claim 1, wherein the electrode is an anode, and
wherein the supporting layer is positioned between the flow field of the anode and the PTL.

17. The electrochemical cell of claim 16, wherein the PTL comprises titanium porous sintered layer, titanium mesh, or titanium fiber felt layer.

18. (canceled)

19. The electrochemical cell of claim 1, wherein the supporting layer is a three-dimensionally (3D)-structured supporting layer, and
wherein the 3D-structured supporting layer comprises a metal wire mesh structure having metal wires protruding outward from a surface of the 3D-structured supporting layer toward the GDL or the PTL.

20. (canceled)

21. The electrochemical cell of claim 19, wherein the metal wires protruding outward from the surface of the 3D-structured supporting layer compress against or protrude into a surface of the adjacent GDL or PTL, therein providing an improved contact or conductivity between the adjacent layers.

22.-23. (canceled)

24. An electrochemical cell comprising:
an electrode having a flow field;
a membrane; and
a self-reinforced porous transport layer (PTL) or self-reinforced gas diffusion layer (GDL) positioned between the flow field and the membrane,
wherein the self-reinforced PTL or the self-reinforced GDL comprises a sublayer arranged in a pattern that is configured to improve a rigidity of the self-reinforced PTL or the self-reinforced GDL, and
wherein the pattern is a honeycomb or hexagonal structure.

25. The electrochemical cell of claim 24, wherein the self-reinforced GDL comprises a carbon fiber sublayer and carbon paper sublayer,
wherein the carbon fiber sublayer is arranged in the pattern to improve a rigidity of the carbon paper sublayer.

26.-27. (canceled)

28. The electrochemical cell of claim 24, wherein the self-reinforced GDL comprises a metal mesh or metal fiber felt sublayer and a carbon fiber or carbon paper sublayer, and
wherein the metal mesh or metal fiber felt sublayer is arranged in the pattern to improve a rigidity of the carbon fiber or carbon paper sublayer.

29.-30. (canceled)

31. The electrochemical cell of claim 28, wherein the metal mesh or the metal fiber felt sublayer is a titanium mesh or titanium fiber felt sublayer.

32. The electrochemical cell of claim 24, wherein the self-reinforced PTL comprises a first metal mesh or metal fiber felt sublayer and a second metal mesh or metal fiber felt sublayer, and
wherein the first metal mesh or metal fiber felt sublayer is arranged in the pattern to improve a rigidity of the second metal mesh or metal fiber felt sublayer.

33.-47. (canceled)
